(19) United States
(12) Patent Application Publication
(10) Pub. No.: US 2014/0331062 A1
(43) Pub. Date: Nov. 6, 2014

(54) SYSTEM AND APPARATUS FOR SECURELY STORING DATA

(71) Applicant: The Provost, Fellows, Foundation Scholars, and the other members of Board, of the College of the ..., Dublin 2 (IE)

(72) Inventors: Hitesh Tewari, Dublin (IE); Karl Reid, Dublin (IE); Desmond Ennis, Dublin (IE)

(73) Assignee: The Provost, Fellows, Foundation Scholars, and the other members of Board, of the College of the ..., Dublin 2 (IE)

(21) Appl. No.: 14/348,288

(22) PCT Filed: Oct. 8, 2012
(86) PCT No.: PCT/EP2012/069895

§ 371 Date: Jun. 4, 2014

(30) Foreign Application Priority Data
Oct. 6, 2011 (GB) 1117275.6
Sep. 19, 2012 (GB) 1216721.9

(51) Int. Cl. G06F 21/60

(52) U.S. Cl. CPC G06F 21/602
USPC 713/189

(57) ABSTRACT

Certain aspects of the invention pertain to the field of networked computing, and in particular to the field of data file security. Methods, systems and apparatuses are disclosed for encrypting and decrypting data stored and shared on networked data file storage devices such that the data may be accessed and manipulated by multiple users.

### TECHNICAL FIELD

This invention relates to the field of networked computing, and in particular to the field of data file security.

### BACKGROUND

Cloud computing is a term used generally to refer to the use, by a client device, of remote computational infrastructure over a network with a view to meeting the data storage and/or computer processing requirements of the client device. This computational infrastructure may be consolidated in a single location as part of a set of substantial computing resources that are made available as required to disparate clients. These computing resources are considered to reside “in the cloud”—i.e. somewhere over the Internet or across a proprietary network. Advances in network communication technologies have resulted in faster communication speed across networks, and this is one of the factors behind a recent increase in the uptake and adoption of cloud computing technologies.

Cloud computing can be advantageous because it substantially reduces the requirement for data processing and data storage resources locally at a client device, and facilitates scalability of projects that require computing resources by enabling easy allocation of additional resources through the cloud as and when required. Cloud computing is also advantageous because it allows multiple users from disparate locales to work collectively via their client devices, using the cloud infrastructure as a hub. Many cloud-based service providers, such as DropBox™, Windows Live™ SkyDrive and Box.net™ now offer online file hosting, providing data storage facilities to users over the Internet. Many of these file-hosting services may be accessed through web-based interfaces via a client device web browser, thus ensuring easy accessibility.

However, a concern with cloud-based systems is that handling and storing of data over the Internet is inherently less secure than handling and storing data on a secure local system. The degree of security with which data are stored by a remote third party (such as a file hosting service provider) is a factor beyond the control of the proprietor of the data. Furthermore, unintended recipients may intercept data passed between a client and a cloud system over a network. As a result, it is desirable that cloud computing achieves a level of security that more closely approaches that offered by local data handling and storage means.

One way of achieving an increased level of data security in cloud-based file hosting systems is to ensure that all data transmitted by the client to the cloud-based file host, and all data stored on the host, is in encrypted form, with the client retaining the encryption/decryption key(s). In such an arrangement, when data are retrieved from the host, it will remain encrypted until decrypted at a client device. Accordingly, when it comes to using the cloud to securely manipulate data, the following simple paradigm may be followed: 1) select the data to be stored on the cloud; 2) encrypt the selected data using a locally-stored encryption key; and 3) upload the encrypted data to the cloud. It will be readily understood that the same principle may be applied in reverse for retrieving data securely stored on the cloud, namely: 1) download the encrypted data from the cloud; 2) select the locally-stored decryption key; and 3) decrypt the data. There are a number of software packages that currently offer such encryption functionality, such as EncFS and TrueCrypt, and it will be understood that there are a variety of ciphers that may be used in the context of the above paradigm.

Cloud computing systems can, however, provide more than mere file hosting functionality. It is also possible—for example—for cloud computing systems to provide client devices with the functionality of productivity suites (also known as office software suites). The capabilities of such suites include, but are not limited to, functionality for producing documents in word-processor, spreadsheet, and slideshow formats. Such functionality may be provided in the form of browser-based client applications such as Google® Docs or Microsoft® Office Web Apps. These browser-based client applications may be in the form of client-side scripting hosted on a website designed to offer this functionality. It will be understood that in this context, “client-side scripting” is computer program code that may be hosted on a server for retrieval by a client device for execution locally on the client device. Accordingly, the web browser may access such client applications dynamically by navigating to said website and retrieving the client-side scripting, for subsequent local execution on the client device. Alternatively, cloud-based storage functionality may be integrated into otherwise locally stored productivity suites, such as is the case with the Microsoft® Office 2010 suite. A particular advantage of providing productivity suite functionality via the cloud is that multiple users can work on a document concurrently, thereby drawing remote workstations into a collaborative environment.

The provision of productivity suite capabilities constitutes a more dynamic functionality of the cloud, when compared to its use as a mere data storage facility. This is because the data transfer between the cloud and the client device(s) in such a scenario can be more fluid, potentially non-linear, and may involve transfer of data from a plurality of client devices. When the cloud is used as a data storage facility, typically the upload of a data file is a single operation that takes place after the data file is complete. When the cloud is used to provide productivity suite capabilities, uploads typically continuously occur as the data file is modified. Moreover, these uploads may emanate from multiple discrete sources in concurrent or near-concurrent fashion. It will thus be appreciated that the encryption paradigm for use when simply storing files on the cloud as defined above is not appropriate when the data content of a file may be dynamically changing. This is because changes may be continually made to a data file, and these changes may be emanating from multiple different sources.

Accordingly, there is a need for a method of providing on-the-fly encryption of data that is manipulated via multiuser online document editing applications in an efficient and provably secure manner. It is desirable that the method allow for simultaneous, collision free, multi-user collaboration and preferably comprises a self-contained solution with no need for ancillary files to support the encryption/decryption process.

### SUMMARY OF THE INVENTION

An embodiment of the invention comprises a method, using a data processing apparatus, of encrypting data for insertion into a data file stored on a data file storage medium, wherein the data file comprises a chronological history of one or more data file elements collectively representing the whole content of the data file, and wherein each data file element corresponds to a data file content manipulation operation, the method comprising: receiving data to be inserted at a designated location of a data file; encrypting the received data using a shared key and a seed string to produce encrypted data, wherein the encrypted data is a first encryption component and the seed string is a second encryption component; generating one or more new data file elements collectively comprising all the encryption components, wherein the encryption components are individually identifiable, and wherein the one or more new data file elements further collectively comprise a signature that allows the one or more new data file elements to be categorized as an encrypted data file element set; and making the one or more new data file elements available for insertion into the chronological history.

This allows for on-the-fly encryption of data in an efficient and provably secure manner.

The data file may comprise a chronological history of revision elements, each of which in turn comprise said one or more chronologically-ordered data file elements, and the one or more new data file elements may be embedded in a new revision element, and the new revision element may be made available for insertion into the chronological history.

The step of encrypting further may use an arbitrary piece of data as additional authentication information, wherein the arbitrary data piece may be a third encryption component. The step of encrypting may be performed utilizing an authenticated encryption scheme such that encryption of the received data further produces an authentication tag, wherein the authentication tag is the arbitrary data piece. The authenticated encryption scheme may be any one of GCM, EAX or CCM.

The one or more new data file elements may further comprise flag data, wherein the flag data may be a fourth encryption component, and wherein the signature in part comprises the flag data. The flag data may comprise at least one non-base64 character and may be included as a delimiter in the one or more new data file elements immediately before the second encryption component.

A plurality of new data file elements may be generated, and the signature may in part comprise a specific sequence of new data file elements, said new data file elements comprising either a data insertion operation or a data deletion operation. The specific sequence may comprise a first data insertion operation for inserting data at the designated location, a second insertion operation for inserting data at the designated location, and a deletion operation for deleting the data inserted by the second insertion operation, the data inserted by the first and second insertion operations comprising the encryption components. The first data insertion operation may comprise the first encryption component, and the second data insertion operation may comprise the remaining encryption components. The first data insertion operation may comprise dummy data, and the second data insertion operation may comprise all encryption components.

The seed string may be a randomly or pseudorandomly generated initialization vector.

The method may further comprise generating a data file element recording the deletion of the entire content of the data file, and a subsequent data file element recording the insertion of the entire content of the data file. This improves the efficiency of the storage process by ensuring that only said data file elements and those succeeding said data file elements are required for the reconstruction of the whole data file.

The data processing apparatus may be located remotely from data file storage medium, said apparatus and said medium being connected over a network. The method may be performed by a standalone application running on the data processing apparatus.

The data to be inserted may be received from a client application executed on the data processing apparatus from within a web browser, and the method may be performed by a plug-in embedded within the web browser.

The data to be inserted may be received from a software application executed on the data processing apparatus, and method may be performed by an extension to the software application or via a separate application that communicates with both the software and the data file store.

The data file may be in a format used to represent documents.

The method may further comprise generating a Message Authentication Code data file element comprising a Message Authentication Code keyed with the secret key, and making the Message Authentication Code data file element available for insertion in the chronological history wherein the Message Authentication Code data file element confirms the authenticity of a preceding data file element.

Another aspect of the invention comprises a method, using a data processing apparatus, of decrypting a portion of a data file that has been encrypted in accordance with the invention, comprising: retrieving, from the data file storage medium, the chronological history of one or more data file elements corresponding to a data file; categorizing one or more data file elements collectively comprising the signature as an encrypted data file element set, identifying the encryption components comprised in the encrypted data file element set, decrypting the encrypted data file element set using the encryption components and the secret key to produce a portion of unencrypted data.

A further aspect of the invention comprises a method, using a data processing apparatus, of decrypting a data file that has been encrypted in accordance with the invention, comprising: retrieving, from the data file storage medium, the chronological history of one or more data file elements corresponding to a data file; for each group of data file elements collectively comprising the signature, categorizing said group as an encrypted data file element set; identifying the encryption components of each encrypted data file element set; constructing a data architecture from all data file elements in the history by applying every data file element to the data architecture in turn, in accordance with their chronological order, wherein the constructed data architecture comprises one or more pieces, each piece referencing at least a portion of a data file element; and for each piece referencing at least a portion of a data file element belonging to an encrypted data file element set, associating the piece with the encryption components of the encryption data file element set to which the referenced data file element belongs; decrypting each of said pieces using the secret key and the associated encryption components.

With respect to any of the above aspects of the invention, collaborating apparatuses in disparate locales may access the data file concurrently, each apparatus having a separate connection to the data file storage medium.

An aspect of the invention comprises a computer readable storage medium carrying a computer program stored thereon, said program comprising computer executable instructions adapted to perform any of the methods described above when executed by a processing module.

Another aspect of the invention comprises a data processing apparatus for encrypting data for insertion into a data file stored on a data file storage medium, wherein the data file comprises a chronological history of one or more data file elements collectively representing the whole content of the data file, and wherein each data file element corresponds to a data file content manipulation operation, the apparatus comprising: means for receiving data to be inserted at a designated location of a data file; means for encrypting the received data using a shared key and a seed string to produce encrypted data, wherein the encrypted data is a first encryption component and the seed string is a second encryption component; means for generating one or more new data file elements collectively comprising all the encryption components, wherein the encryption components are individually identifiable, and wherein the one or more new data file elements further collectively comprise a signature that allows the one or more new data file elements to be categorized as an encrypted data file element set; means for making the one or more new data file elements available for insertion into the chronological history.

The data file may comprise a chronological history of revision elements, each of which in turn comprise said one or more chronologically-ordered data file elements; the means for generating one or more new data file elements may additionally comprise means for generating a new revision element and means for embedding the one or more new revision elements in said new revision element, and the means for making the one or more new data file elements available may make said new revision element available and thus said embedded one or more new data file elements available for insertion into the chronological history.

The means for encrypting may further use an arbitrary piece of data as additional authentication information, wherein the arbitrary data piece is a third encryption component. The means for encrypting may utilize an authenticated encryption scheme such that encryption of the received data further produces an authentication tag, wherein the authentication tag is the arbitrary data piece. The authenticated encryption scheme may be any one of GCM, EAX or CCM. The one or more new data file elements may further comprise flag data, wherein the flag data is a fourth encryption component, and wherein the signature in part comprises the flag data. The flag data may comprise at least one non-base64 character and is included as a delimiter in the one or more new data file elements immediately before the second encryption component.

The means for generating may generate a plurality of new data file elements, the signature may in part comprise a specific sequence of new data file elements, said new data file elements comprising either a data insertion operation or a data deletion operation.

The specific sequence may comprise a first data insertion operation for inserting data at the designated location, a second insertion operation for inserting data at the designated location, and a deletion operation for deleting the data inserted by the second insertion operation, the data inserted by the first and second insertion operations comprising the encryption components. The first data insertion operation may comprise the first encryption component, and the second data insertion operation may comprise the remaining encryption components. The first data insertion operation may comprise dummy data, and the second data insertion operation may comprise all encryption components.

The seed string may be a randomly or pseudorandomly generated initialization vector.

The means for generating may further comprise means for generating a data file element recording the deletion of the entire content of the data file, and means for generating a subsequent data file element recording the insertion of the entire content of the data file.

The data processing apparatus may be located remotely from data file storage medium, said apparatus and said medium being connected over a network.

The means for receiving, encrypting, generating and making may be comprised in a standalone application running on the data processing apparatus.

The data to be inserted may be received from a client application executed on the data processing apparatus from within a web browser, and the means for receiving, encrypting, generating and making may be comprised in a plug-in embedded within the web browser.

The data to be inserted may be received from a software application executed on the data processing apparatus, and the means for receiving, encrypting, generating and making may be comprised in an extension to the software application or in a separate application that communicates with both the software and the data file store.

The means for generating may further comprise means for generating a Message Authentication Code data file element comprising a Message Authentication Code keyed with the secret key, and the means for making may further comprise means for making the Message Authentication Code data file element available for insertion in the chronological history wherein the Message Authentication Code data file element confirms the authenticity of a preceding data file element.

Another aspect of the invention comprises a data processing apparatus for decrypting a portion of a data file that has been encrypted in accordance with the invention, the apparatus comprising: means for retrieving, from the data file storage medium, the chronological history of one or more data file elements corresponding to a data file; means for categorizing one or more data file elements collectively comprising the signature as an encrypted data file element set, means for identifying the encryption components comprised in the encrypted data file element set, means for decrypting the encrypted data file element set using the encryption components and the secret key to produce a portion of unencrypted data.

A further aspect of the invention comprises a data processing apparatus, for decrypting a data file that has been encrypted in accordance with the invention, the apparatus comprising: means for retrieving, from the data file storage medium, the chronological history of one or more data file elements corresponding to a data file; means for categorizing, wherein for each group of data file elements collectively comprising the signature, the means for categorizing categorizes said group as an encrypted data file element set; means for identifying the encryption components of each encrypted data file element set; means for constructing a data architecture from all data file elements in the history by applying every data file element to the data architecture in turn, in accordance with their chronological order, wherein the constructed data architecture comprises one or more pieces, each piece referencing at least a portion of a data file element; means for associating, wherein for each piece referencing at least a portion of a data file element belonging to an encrypted data file element set, the means for associating associates the piece with the encryption components of the encryption data file element set to which the referenced data file element belongs; and means for decrypting each of said pieces using the secret key and the associated encryption components.

An additional aspect of the invention comprises a system comprising a plurality of apparatuses in accordance with the invention wherein at least two of said apparatuses are at disparate locales and may access the same data file concurrently, each of said at least two apparatuses having a separate connection to the data file storage medium.

### BRIEF DESCRIPTION

The invention will be more clearly understood from the following description of an embodiment thereof, given by way of example only, with reference to the accompanying drawings, in which:

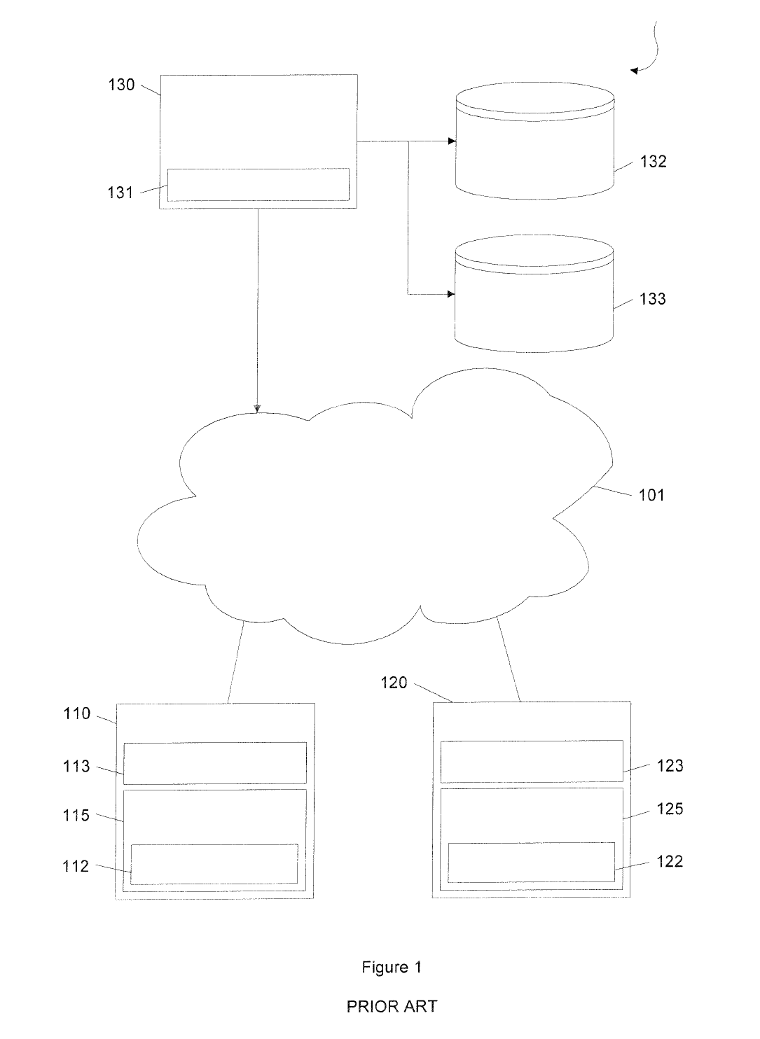

FIG. 1 is a schematic of a cloud-based data manipulation system in accordance with the prior art;

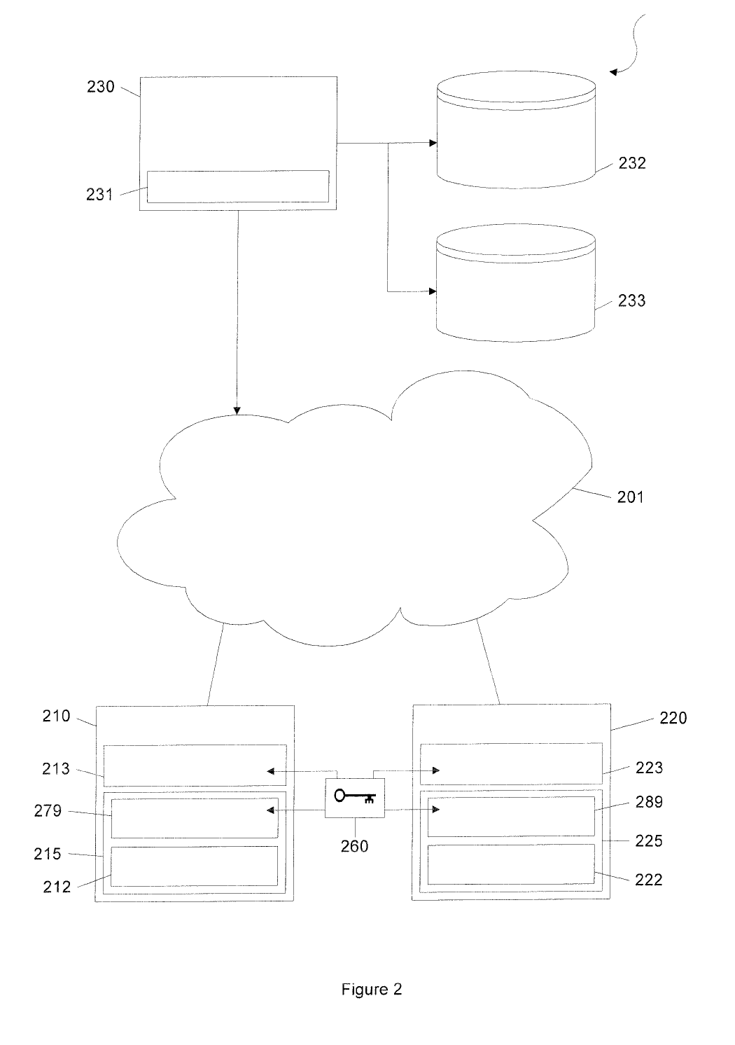

FIG. 2 is a schematic of a secure cloud-based data manipulation system in accordance with the claimed invention;

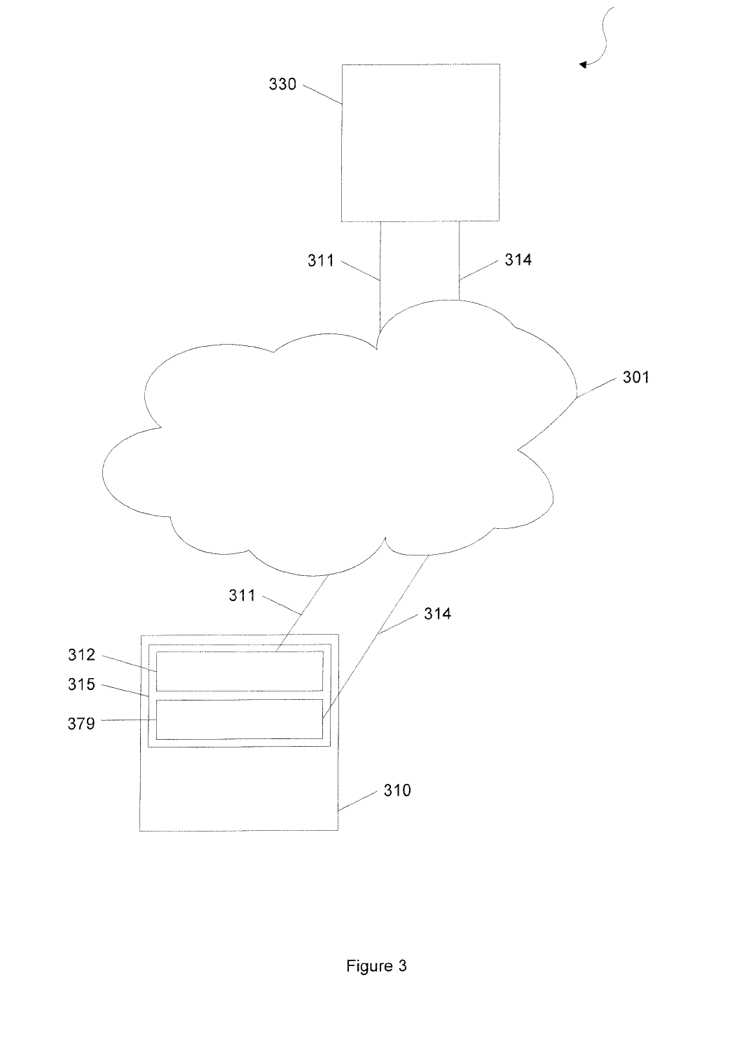

FIG. 3 is a schematic of the interrelationship between web browser software, a client application and a bespoke plug-in in an embodiment of the invention where data manipulation functionality is comprised in the client application, which is retrieved by the web browser over a network and subsequently run within the web browser, and wherein the bespoke plug-in ensures the manipulated data are encrypted before they are relayed to the cloud-based data manipulation system;

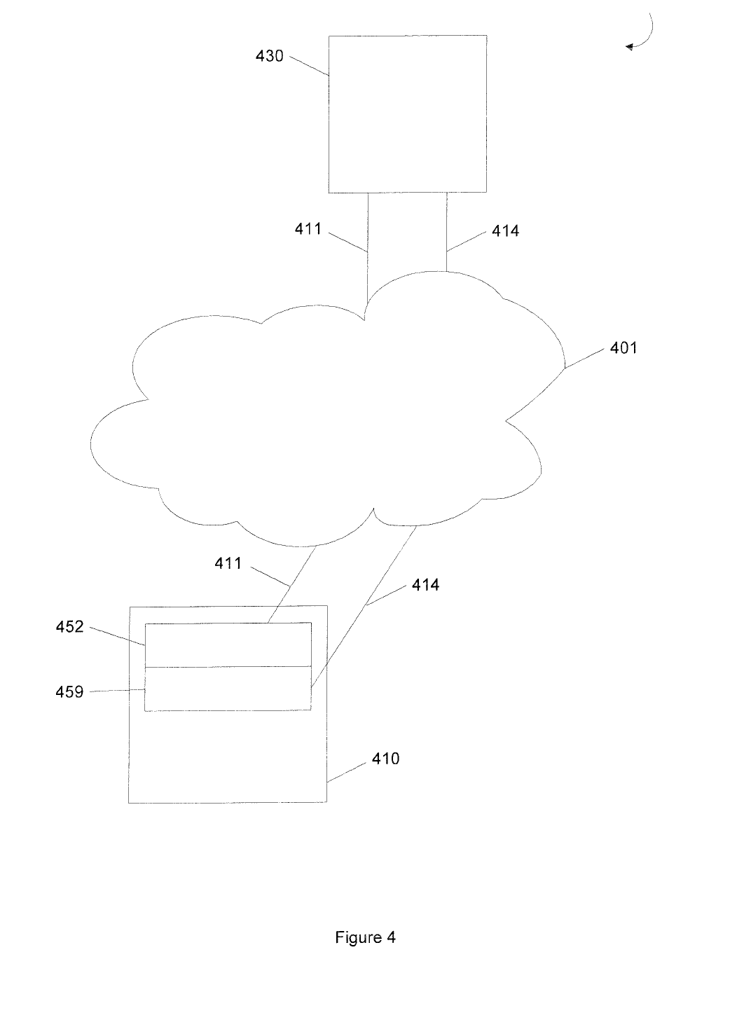

FIG. 4 is a schematic of the interrelationship between the productivity/office software and the bespoke extension in an embodiment of the invention where data manipulation functionality is provided by the locally stored productivity/office software, and wherein the bespoke extension ensures the manipulated data are encrypted before they are relayed to the cloud-based data manipulation system;

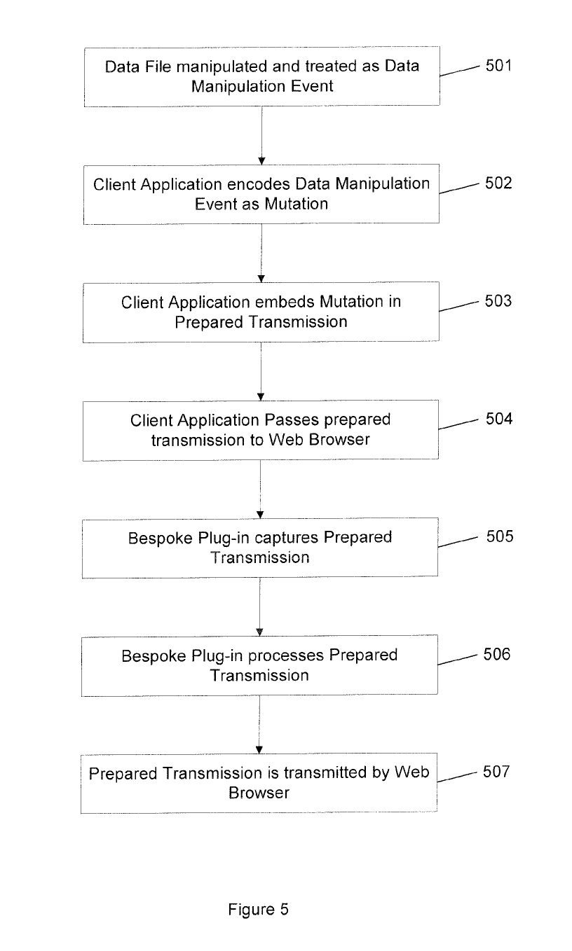

FIG. 5 illustrates the process by which the embodiment of the invention depicted in FIG. 3 may record, encrypt and transmit manipulated data;

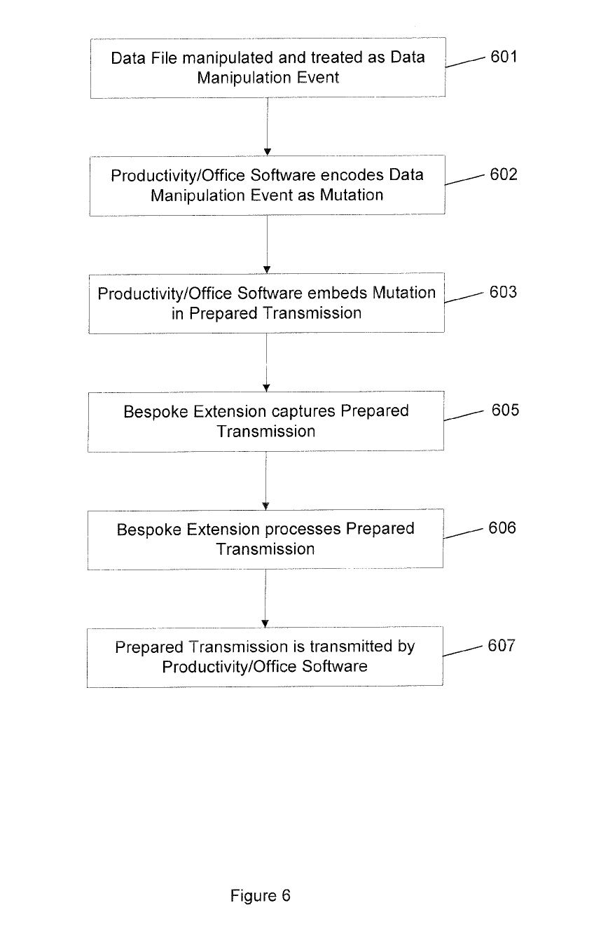

FIG. 6 illustrates the process by which the embodiment of the invention depicted in

FIG. 4 may record, encrypt and transmit manipulated data;

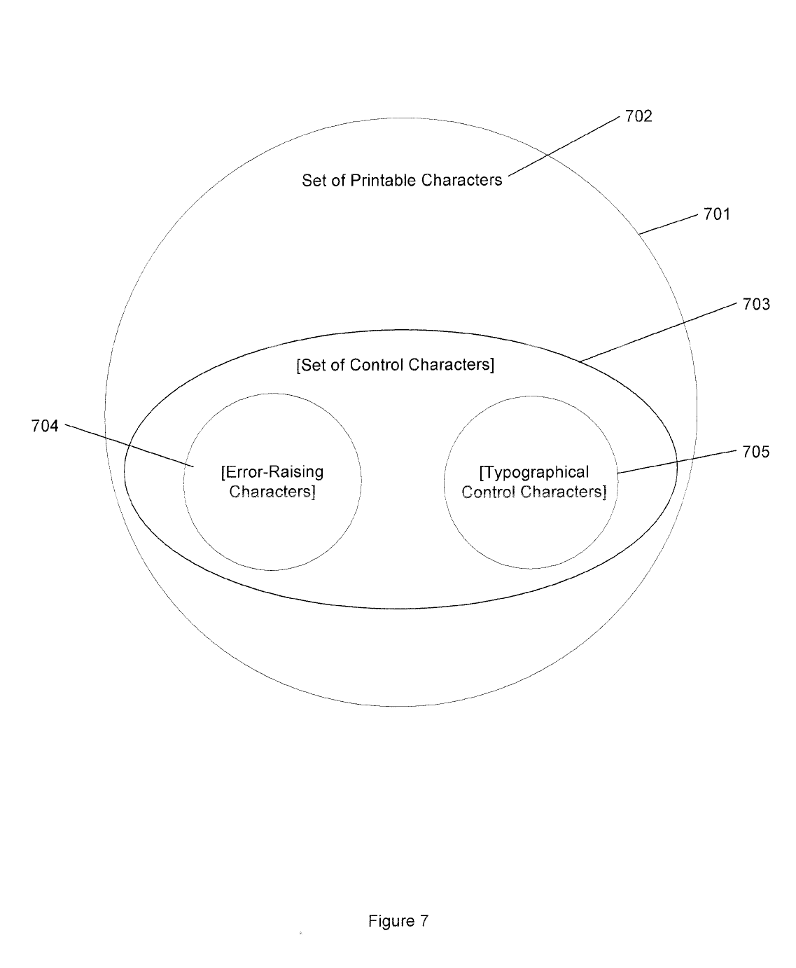

FIG. 7 is a schematic of the universal set of all UTF-8 characters and a number of subsets that exist within this universal set;

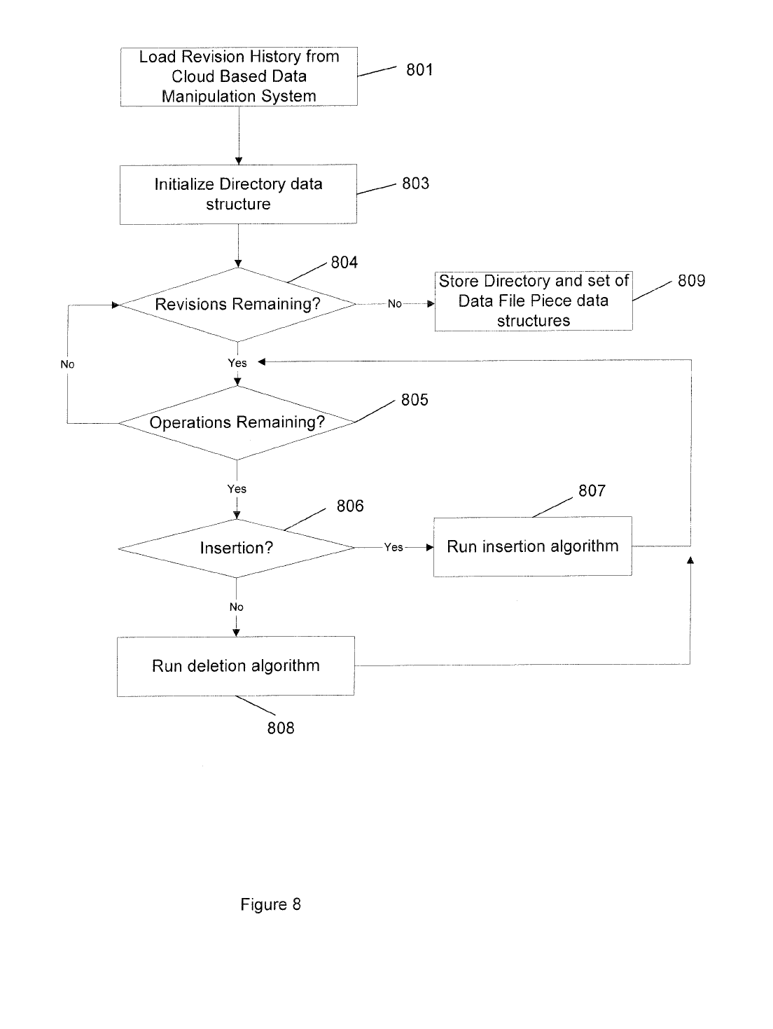

FIG. 8 illustrates the process by which a data architecture representative of the data file may be constructed in accordance with one embodiment of the invention;

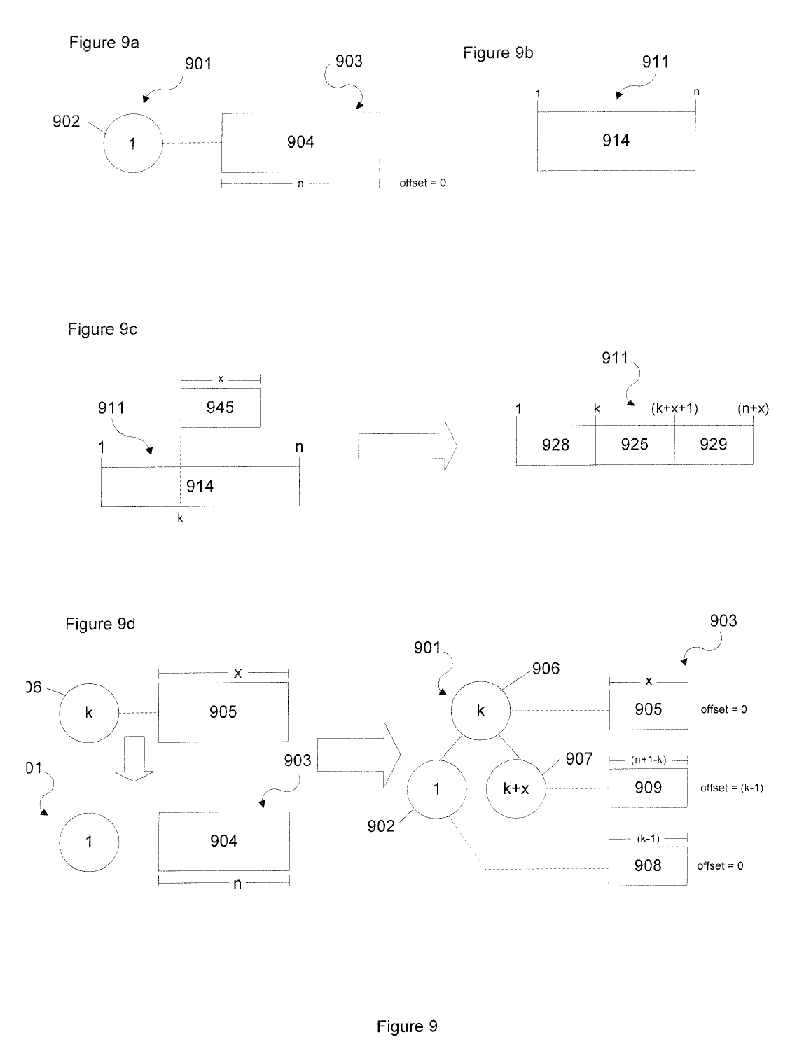

FIG. 9 illustrates the process by which the data architecture representative of the data file in accordance with one embodiment of the invention may be updated with an insertion of additional data content;

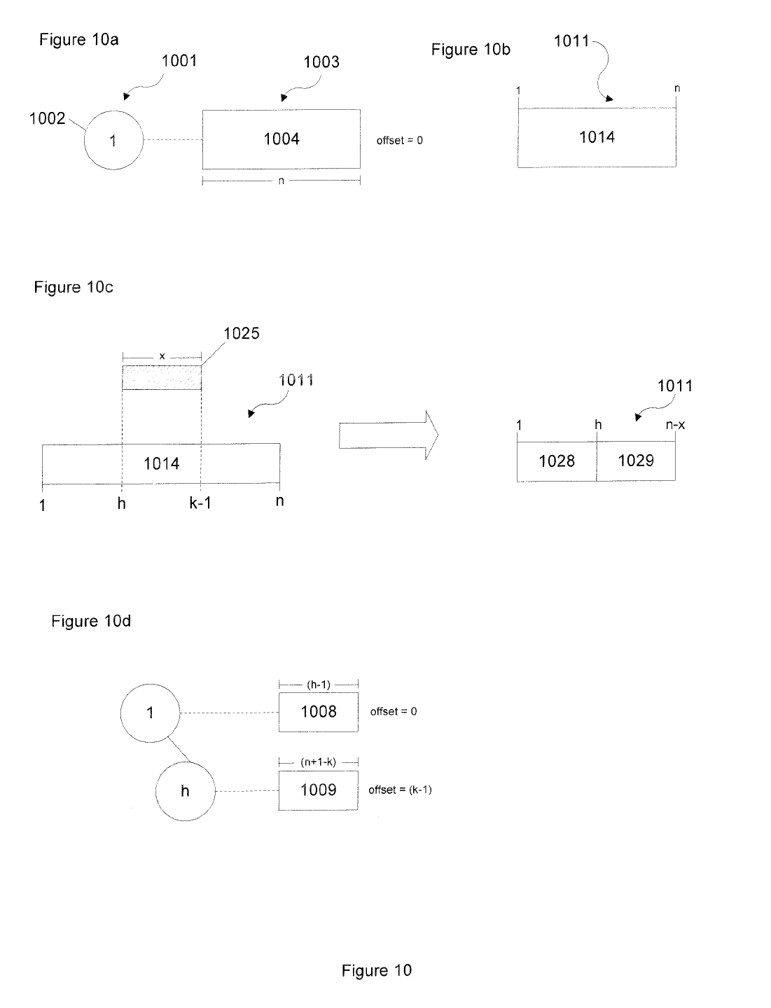

FIG. 10 illustrates the process by which the data architecture representative of the data file in accordance with one embodiment of the invention may be updated with a deletion of existing data content;

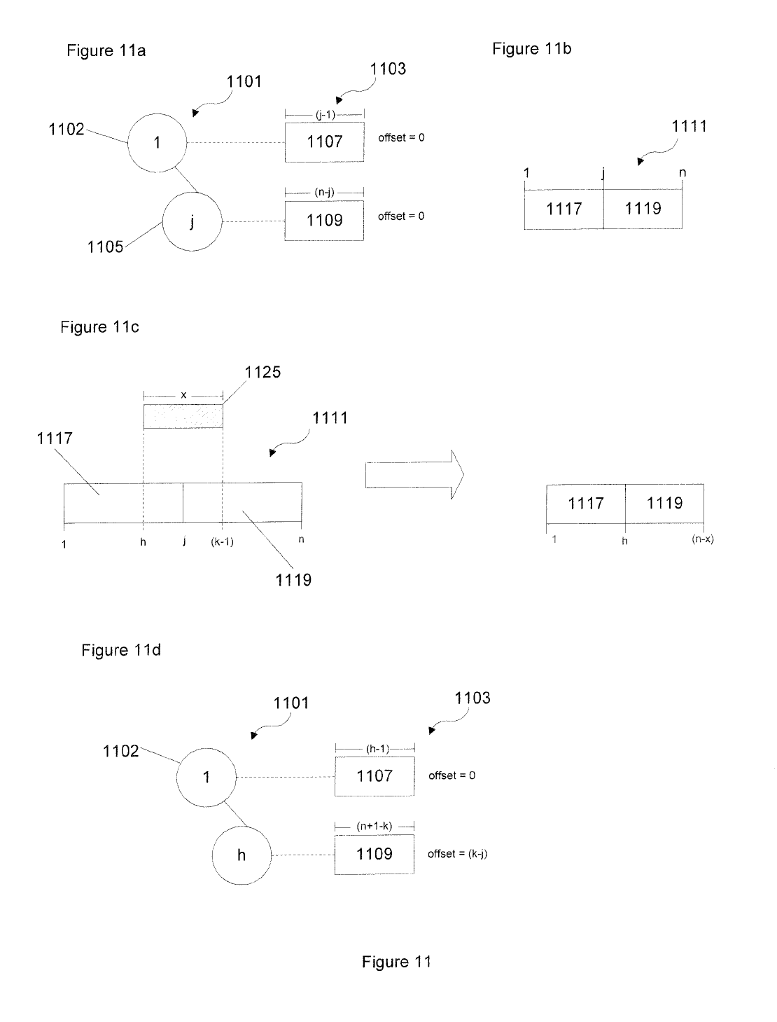

FIG. 11 illustrates a second process by which the data architecture representative of the data file in accordance with one embodiment of the invention may be updated with a deletion of existing data content;

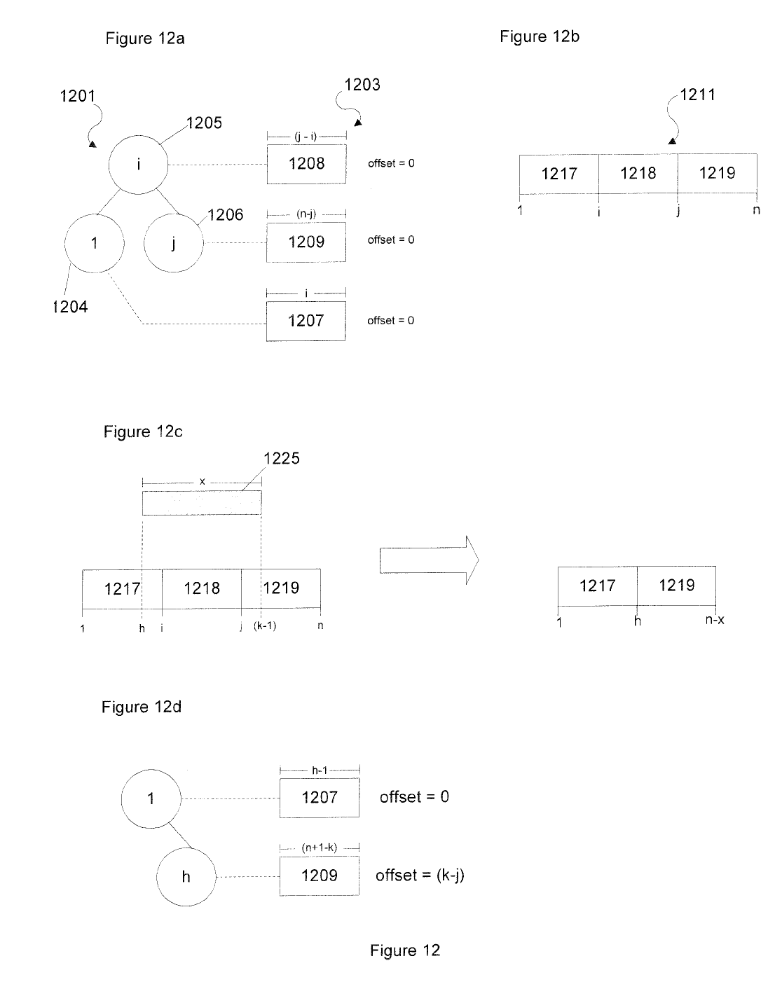

FIG. 12 illustrates a third process by which the data architecture representative of the data file in accordance with one embodiment of the invention may be updated with a deletion of existing data content; and

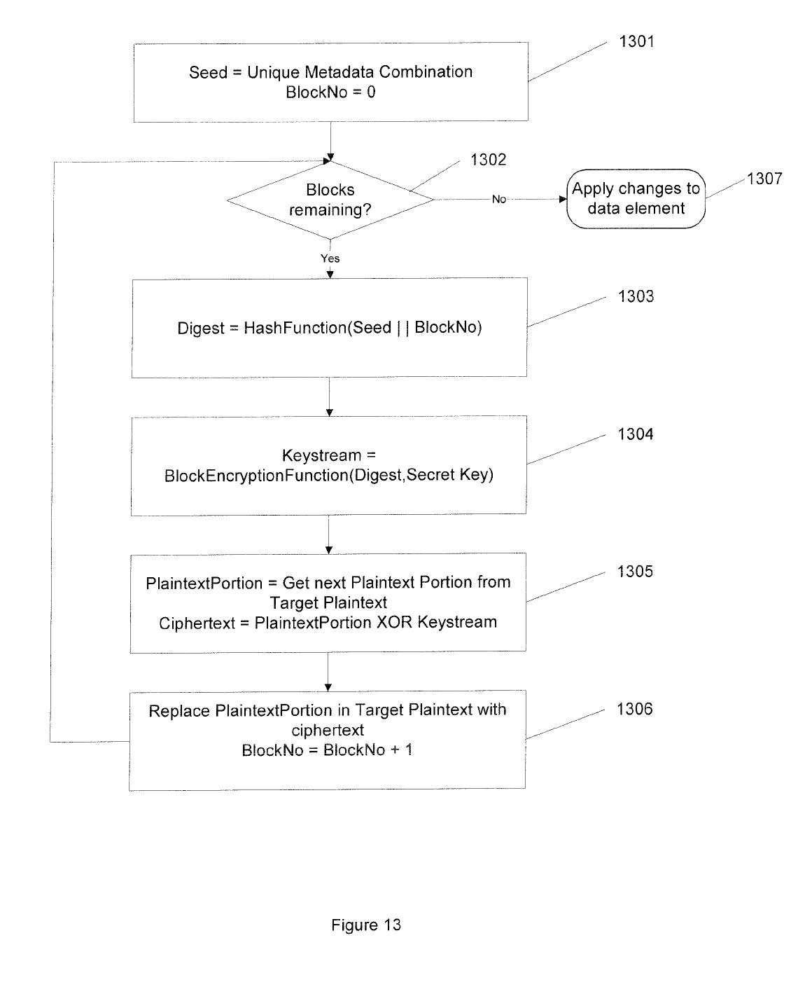

FIG. 13 is a schematic illustrating how data file elements may be encrypted using a keystream cipher, and how the keystream cipher may be generated.

### DETAILED DESCRIPTION

### Program Architecture of Prior Art

FIG. 1 is a diagram illustrating an architecture for providing a cloud-based data manipulation system 100 that accommodates concurrent data manipulation by multiple users in accordance with the prior art. A network 101 facilitates communication between a remote (i.e. “cloud-based”) server 130 acting as a document creation, editing and storage facility and a plurality of client devices 110, 120. It will be appreciated that the network 101 may comprise the Internet, a proprietary network, or a combination of the two. Client devices 110, 120 may be disparately located, and may connect to the network 101 by way of one or more of a variety of technologies, such as Ethernet, DSL, ISDN, Wi-Fi, WiMax, 2G, 3G, LTE, 4G, etc. Client devices 110, 120 may be any of a variety of devices including desktop personal computers, laptops, tablet personal computers, personal digital assistants, mobile phones etc. Server 130 is also connected to network 101, and comprises means for providing data manipulation functionality 131 across the network 101. Server 130 is also associated with means for storing manipulated data 132, and means for storing metadata associated with the stored manipulated data 133. It will be appreciated that alternative arrangements of data file storage media exist to the arrangement of the server 130 illustrated in FIG. 1. For example, the server 130, the means for storing manipulated data 132 and the means for storing associated metadata 133 may comprise a single server, with shared storage means.

Client devices 110 and 120 may avail of data manipulation functionality by accessing the means for providing data manipulation functionality 131 located on server 130 over the network 101. The client devices 110 and 120 may access the means for providing data manipulation functionality 131 over the network 101 using respective web browser software 115, 125. The data manipulation functionality may comprise browser-based client applications 112, 122 which may be in the form of client-side scripting. The browsers 115, 125 may dynamically retrieve the respective client applications 112, 122 from the means for providing data manipulation functionality 131, thereby allowing for subsequent local execution of the client applications 112, 122 on respective client devices 110, 120. Examples of such client applications include those provided by the Google® Docs or Microsoft® Office Web Apps systems. Alternatively, the means for providing data manipulation functionality 131 may be accessed over the network via bespoke productivity/office software 113, 123 located respectively in clients 110, 120. An example of such productivity/office software is Microsoft® Office 2010. Any one of a number of protocols may be used to allow access to this data manipulation functionality. In a preferred embodiment, Hypertext Transfer Protocol Secure (HTTPS) may be used, but it will readily understood that any request/response transaction protocol may be appropriate for this purpose. It will be appreciated that although a plurality of client devices are depicted, a plurality of client devices are not essential to the functioning of this arrangement.

### Program Architecture of Invention

FIG. 2 is a diagram illustrating an architecture for providing a cloud-based data manipulation system 200 that accommodates concurrent data manipulation by multiple users in accordance with an embodiment of the invention. The architecture of the system 200 is analogous to that of system 100 to the extent that labelled parts 201 to 233 of FIG. 2 correspond to labelled parts 101 to 133 of FIG. 1. It will be appreciated that the variety of embodiments contemplated for the system of FIG. 1 are also analogously contemplated for the system of FIG. 2 where applicable, and that—as with FIG. 1—a plurality of client devices are not essential to the functioning of this arrangement.

The system of FIG. 2 differs from that of FIG. 1 in that it ensures only encrypted data are stored on manipulated data storage means 232 associated with server 230. This is achieved by ensuring that all data manipulated at the clients 210, 220 are encrypted before they are transmitted over the network 201 to the server 230. The encryption may be done in real time, as the data are manipulated, using a shared secret key 260, known only to the users of the client devices 210, 220.

In one embodiment of the invention, data may be manipulated in web browsers 215, 225, using the functionality of respective client applications 212, 222, where the client applications have been previously downloaded from the cloud. The manipulated data are then passed to bespoke plug-ins 279, 289, these plug-ins being embedded respectively in the web browsers 215, 225. The bespoke plug-ins 279, 289, encrypt the manipulated data, and then the encrypted data are passed on to the manipulated data storage means 232 associated with server 230 for storage. Conversely, when a client device in accordance with this embodiment of the invention retrieves encrypted data from the manipulated data storage means 232 associated with server 230, the data are passed to bespoke plug-ins 279, 289. The plug-ins 279, 289 decrypt the data and then the decrypted data are passed on to respective web browsers 215, 225, where they may be processed by client applications 212, 222 for presentation to the user for subsequent possible manipulation. Decrypted data are only housed locally and temporarily on the client devices, preferably in the cache of the web browsers 215, 225, before subsequent re-encryption and committal to the manipulated data storage means 232 associated with server 230.

A variation of the above embodiment exists where it is not possible or else inefficient to house the encryption and decryption functionality in a web browser based plug-in. For example, as different web browsers have different APIs, plug-in support is not necessarily conserved across all web browsers. Accordingly, to ensure cross-browser compatibility of the encryption and decryption functions, it may be preferable to house this functionality in standalone applications (not shown) residing on the client devices 210, 220. This standalone application may function as a “man in the middle” proxy in a manner analogous to the manner in which the bespoke plug-ins 279, 289 above. In other words, after data is manipulated in web browsers 215, 225 using the functionality of respective client applications 212, 222, the manipulated data are then passed to the standalone applications. The standalone applications encrypt the manipulated data, and the encrypted data are then passed on to the manipulated data storage means 232 associated with server 230 for storage. Conversely, when a client device in accordance with this embodiment of the invention retrieves encrypted data from the manipulated data storage means 232 associated with server 230, the data are passed initially to the standalone applications. The standalone applications decrypt the data and then the decrypted data are passed on to respective web browsers 215, 225, where they may be processed by client applications 212, 222 for presentation to the user for subsequent possible manipulation.

In an alternative embodiment of the invention, data may be manipulated in productivity/office software 213, 223. Bespoke extensions to the software 213, 223 may then encrypt the data, and then the encrypted data are passed on to the manipulated data storage means 232 associated with server 230 for storage. The bespoke extension is discussed in greater detail below with reference to FIG. 4. Conversely, when a client device in accordance with this embodiment of the invention retrieves encrypted data from the manipulated data storage means 232 associated with server 230, the data are passed to the bespoke extensions of the software. The extensions decrypt the data and then the decrypted data may be processed by the productivity/office software 213, 223 for presentation to the user for subsequent possible manipulation. In this case, decrypted data are only housed locally and temporarily on the client devices, preferably in the cache of the productivity/office software 213, 223, before subsequent re-encryption and committal to the manipulated data storage means 232 associated with server 230. It will be appreciated that rather than provide the encryption functionality by way of extensions to the productivity/office software, it may alternatively be possible to provide this functionality to productivity/office software by way of a separate application stored on the client device that acts as an intermediary in the communication link between the productivity/office software and the cloud.

A variation of this embodiment also exists whereby rather than using bespoke software extensions, standalone applications are used (as previously described) in order to encrypt and decrypt the data.

FIG. 3 depicts the interrelationship between the client application, the web browser software and the bespoke plug-in in the embodiment of the invention in which data manipulation functionality is provided via a client application that may be run from within a web browser. As previously mentioned, examples of client applications that allow data manipulation functionality to be provided in such a way include the client applications made available by the Google® Docs and Microsoft® Office Web Apps systems. These browser-based client applications may be in the form of client-side scripting which may be retrieved from a host website by a web browser for subsequent local execution on the client device. A system 300 is depicted wherein a client device 310 is in contact with a cloud-based data manipulation system 330, over a network 301. Web browser software 315 may be run from within client device 310, and may be used to navigate to a location on the World Wide Web where a client application 312 that offers data manipulation functionality may be accessed and retrieved. The web browser software 315 also houses a bespoke plug-in 379 that is configured to ensure that all manipulated data transmitted from the client device 310 are transmitted in encrypted form. The client application 312 may have a connection 311 to the cloud-based data manipulation system 330, the connection preferably being over a request/response transaction protocol, which in a preferred embodiment is HTTPS. This connection will hereafter be referred to as the “primary channel”. The client application 312 may relay/receive the requests/responses through the web browser software 315. In the embodiment of the invention depicted in FIG. 3, the bespoke plug-in 379 maintains an independent connection 314 with the cloud-based data manipulation system 330. This connection 314 may also be over a request/response transaction protocol, which in a preferred embodiment is HTTPS. This connection will hereafter be referred to as the “secondary channel”. This second connection is necessary for reasons that will be discussed in more detail below.

As has been described with respect to FIG. 2, a standalone application may be utilized in place of bespoke plug-in 379, and is used in a manner analogous to the manner in which plug-in 379 is utilized in the above paragraph.

FIG. 4 depicts the embodiment of the invention in which data manipulation functionality is provided via bespoke functionality built as an extension to the productivity/office software residing on the client device. The interrelationship between the extension and the productivity/office software is shown. As previously mentioned, an example of such a productivity/office software suite is Microsoft® Office 2010. A system 400 is depicted wherein a client device 410 is in contact with a cloud-based data manipulation system 430, over a network 401. Client device 410 hosts productivity/office software 452 that provides data manipulation functionality and also hosts a bespoke extension 459 that ensures such data are encrypted before they are relayed to data manipulation system 430. The productivity/office software 452 may have a connection 411 to the cloud-based data manipulation system 430, the connection preferably being over a request/response transaction protocol, which in a preferred embodiment is HTTPS. This connection will hereafter be referred to as the “primary channel”, as it performs essentially the same functions as the primary channel described in the embodiment of the invention referenced with respect to FIG. 3. In the embodiment of the invention depicted in FIG. 4, the bespoke extension 459 maintains an independent connection 414 with the cloud-based data manipulation system 430. This connection 414 may also be over a request/response transaction protocol, which in a preferred embodiment is HTTPS. This connection will hereafter be referred to as the “secondary channel”, as it performs essentially the same functions as the secondary channel described in the embodiment of the invention referenced with respect to FIG. 3. As with the embodiment of the invention depicted in FIG. 3, the second connection in the embodiment of the invention depicted in FIG. 4 is necessary for reasons that will be discussed in more detail below.

As has been described with respect to FIG. 2, a standalone application may be utilized in place of bespoke extension 459, and is used in a manner analogous to the manner in which extension 459 is utilized in the above paragraph.

### Data Recordal

FIG. 5 illustrates how the embodiment of the invention depicted in FIG. 3 may ensure that all manipulated data transmitted from the client device 310 to the cloud-based data manipulation system 330 are in encrypted form. The user of client device 310 may be presented with a data file via web browser 315, and may be afforded the ability to manipulate the data in the data file via client application 312. Referring now to FIG. 5, when the user manipulates 501 the data in such a data file, it may be regarded as a data manipulation event. The changes to the data file embodied by the data manipulation event are recorded 502 by the client application 312 and encoded as a “mutation”. Data manipulation events may comprise one or more discrete and chronologically successive data manipulation operations, and these data manipulation operations include, but are not limited to, data insertion operations (comprising the insertion into the data file content of a contiguous string of data) and data deletion operations (comprising the deletion from the data file content of a contiguous string of data). Data manipulation events that comprise a chronologically successive set of such discrete insertion and deletion operations may also be recorded in a single mutation. In other words, a mutation may encode a data manipulation event, which in turn may comprise one or more insertion and/or deletion operations.

In some embodiments, the amount of data manipulation that may be recorded in a single mutation is a matter of preference, and it will be appreciated that the client application 312 may therefore be configured to record mutations according to such preferences. The point at which a discrete mutation is recorded may be as the result of a function of one or more variables, such as the duration of the data manipulation event to date, the extent of change that has taken place to the data file over the course of the data manipulation event to date, the idle time since the last action by the user and/or as a result of receiving certain prompts from the cloud based data manipulation system 330. It will thus be appreciated that extensive data manipulation sessions may be recorded as a series of data manipulation events. For example, if a large amount of data is being inserted, the client application may be configured to view this as a series of successive data insertion operations, and to include one or more of these successive data insertion operations in different mutations for committal to the cloud based data manipulation system.

In some embodiments, the cloud based data manipulation system is controlled and administered by a third party. In such embodiments, the amount of data manipulation recorded per mutation by the client application is only configurable by said third party. In one embodiment, the client application is configured to typically treat the insertion of approximately every one or two characters as a separate mutation. Accordingly, in this embodiment, where a user inserts a long string of data, the client application will treat this as a series of mutations, each of between one to two characters. Furthermore, in this embodiment, where a deletion operation succeeds an insertion operation, the client application is configured to typically treat the deletion operation as a separate mutation to the preceding insertion operation. In the conventional use of this embodiment, it is therefore unlikely that a mutation will relate to a data manipulation event comprising a plurality of data manipulation operations.

Once the mutation has been encoded at step 502, the client application 312 may prepare a request for transmitting the mutation to the cloud based data manipulation system 330, and may embed 503 the mutation within the prepared request. The prepared request may, for example, comprise an HTTPS request. The client application 312 may then pass 504 the prepared request to the web browser 315 for transmission.

Prior to transmission of the prepared request from the web browser 315 to the cloud based data manipulation system 330, the bespoke plug-in 379 may capture 505 the prepared request. The bespoke plug-in 312 may then process 506 the mutation embedded in the prepared request, encrypting the data manipulation event recorded within the mutation, and thereby ensuring that all manipulated data transmitted to the cloud based data manipulation system 330 is transmitted in encrypted format. When a data manipulation event is encrypted in this way, the set of individual data manipulation operations comprising the data manipulation event will be encrypted individually. Operations that involve the addition of new content may have that content encrypted. Accordingly, the content of data insertion operations will be encrypted. It may be possible to also encrypt the information relating to a deletion operation, such as where in a data file the deletion is to be made, the size of the deletion, etc. However, because they do not entail the addition of any new content, it is not strictly necessary to encrypt deletion operations. The manner in which individual operations may be encrypted will be described in greater detail below. Once the content of all insertion operations in a mutation have been encrypted, the mutation has been processed.

Once the mutation embedded within a prepared request has been encrypted, the prepared request is then transmitted 507 to the cloud based data manipulation system 330 by the web browser 315 so that the mutation may be committed to the data file stored thereon. The mutation may be committed to the stored data file in a number of ways. In one embodiment of the invention, known as the “Revision Model” embodiment, each data manipulation operation in each mutation is stored individually on the cloud based data manipulation system 330 in a chronological history of such operations. The full history of such operations is representative of the data file in its up to date state. This embodiment is described in detail below, where each mutation is referred to as a “revision element”. In this embodiment of the invention, the cloud-based data manipulation system 330 may subsequently transmit a confirmation to the client device confirming that the mutation has been received, that the set of operations contained therein have been stored, and informing the client device of each operation's chronological position within the chronological history of stored operations. In an alternative embodiment of the invention a chronological history of operations may not be recorded, and the mutation—once received by the cloud based data manipulation system 330—may be directly applied to the data file, and the data file itself stored in an up-to date format.

FIG. 6 illustrates how the embodiment of the invention depicted in FIG. 4 may ensure that all manipulated data transmitted from the client device 410 to the cloud-based data manipulation system 430 are in encrypted form. Similar to the previous embodiment, the user of client device 410 may be presented with a data file via productivity/office software 452, which may also afford the user the ability to manipulate the data in the data file. Referring now to FIG. 6, when the user manipulates 601 the data in such a data file, it may be regarded as a data manipulation event. The changes to the data file embodied by the data manipulation event are recorded 602 by the productivity/office software 452 and encoded as a “mutation”, as previously described with respect to FIG. 5. As with FIG. 5, the amount of data manipulation that may be recorded in a single mutation is a matter of preference of the party controlling the cloud based data manipulation system. With respect to the embodiment depicted in FIG. 6, it will be appreciated that the productivity/office software 452 may be configured to record mutations according to such preferences if the party controlling the could based data manipulation system is also responsible for supplying the productivity/office software. Examples of considerations that may be taken into account when determining when to record a mutation are described with reference to FIG. 5.

Once the mutation has been encoded at step 602, the client application productivity/office software 452 may prepare a request for transmitting the mutation to the cloud based data manipulation system 430, and may embed 603 the mutation within the prepared request. The prepared request may, for example, comprise an HTTPS request.

Similar to the previous embodiment, prior to the transmission of the prepared request from the productivity/office software 452 to the cloud based data manipulation system 430, the bespoke extension 459 may capture 605 the prepared request. The bespoke extension 459 may then process 606 the mutation embedded in the prepared request, encrypting the data manipulation event recorded within the mutation, and thereby ensuring that all manipulated data transmitted to the cloud based data manipulation system 430 is transmitted in encrypted format. The manner in which the mutation is processed proceeds in a fashion analogous to that described with reference to step 506 of FIG. 5.

Once the mutation embedded within a prepared request has been encrypted, the prepared request is then transmitted 607 to the cloud based data manipulation system 430 so that the mutation may be committed to the data file stored thereon. With respect to the Revision Model embodiment, the data manipulation operations comprised in the mutation may be committed chronologically to the stored data file as described above.

While the FIGS. 5 and 6 are described in the context of data manipulation events related to an existing data file, it will be appreciated that the creation of a new data file and the first insertion of data into said data file in itself also constitutes a data manipulation event. Accordingly, with respect to the Revision Model embodiment, the creation and initial insertion of content into a data file may be stored as the first operation in such a history. Accordingly, in such an embodiment, the history of operations comprises a self-contained representation of the data file. In one embodiment of the invention, mutations comprising these operations may be transmitted to the cloud based data manipulation system over the primary channel.

### Data Recordal—Character Handling

In order to ensure that the manipulated data are successfully and efficiently encrypted prior to their being relayed to the cloud-based data manipulation system, it is necessary to first ensure that the data to be encrypted do not contain characters that will cause a problem during the encryption process. In one embodiment, the data being manipulated may be in the form of a text document comprising UTF-8 characters. However, it will be readily appreciated that other data and/or character formats may also be used. In the embodiment where the text document comprises UTF-8 characters, it is necessary to ensure prior to encryption that the document does not contain any characters that might raise an error when handled by the data manipulation functionality, as this could cause problems during the encryption process. FIG. 7 depicts the universal set of all UTF-8 characters 701, which comprises the set of all printable characters 702 and the set of control characters 703. The set of control characters 703 in turn comprises characters 704 that might raise an error when handled by the data manipulation functionality such as End of Transmission (“EOT”), Bell (“BEL”), Synchronous Idle (“SYN”) and Acknowledge (“ACK”), and typographical control characters 705 such as “space”, “newline” or “tab”. In this embodiment, any error-raising characters in the manipulated data may be stripped out by projecting all characters in the data onto an abridged subset of UTF-8 characters that excludes error-raising characters, thereby allowing for error-free encryption.

Revision Model—overview

In order to obviate the need to re-encrypt an entire data file whenever its content is manipulated, each data file may be represented by a series of discrete elements which, when taken together are collectively representative of the complete data file. By way of example, in the Revision Model embodiment previously described, each data file element may represent a discrete change made to the data file content at a specific point in time (a “data file content manipulation operation”), with each new change giving rise to a new corresponding data element. In the Revision Model, when changes are made to the data file, it is sufficient to only encrypt the data file element representative of the change and relay it to the cloud-based data manipulation system for storage. The full set of such data file elements, when taken together, thus comprise a history of all changes made to the data file, and the data file can therefore be reconstructed from this full set of data file elements. As will be described in greater detail below, each data file element may be encrypted on the basis of a secret key and its own unique seed string. Using a different, unique seed string for each separate data element effectively eliminates the threat that the data file may be compromised via a re-use attack if a stream cipher encryption scheme is used to perform the encryption.

As discussed above, in the Revision Model embodiment, the data file elements may each represent a discrete, chronologically successive data file content manipulation operation. Data file content manipulation operations include discrete data insertion operations (comprising the insertion into the data file content of a contiguous string of data) and also include discrete data deletion operations (comprising the deletion from the data file content of a contiguous string of data). Data file elements in the form of data file content manipulation operations will be referred to as “operation elements”. One or more chronologically successive operation elements may be regarded as a “data manipulation event”. In the Revision Model of the invention, the operation elements comprised in data manipulation events may be recorded and then applied to the data file content. Data manipulation events recorded in this way will hereafter be referred to as “revision elements”. Therefore, a revision element may comprise a set of one or more successive operation elements. The data file may be stored on the cloud-based data manipulation system in this manner, as a history of successive encrypted operation elements, each belonging to a specific revision element (this history will be referred to as a “revision history”). As such, revision elements may be synonymous with the mutations described in reference to FIGS. 5 and 6, and operation elements may correspond to individual operations within the mutations of FIGS. 5 and 6. Each operation element within each of these revision elements may be associated with a unique combination of relevant metadata. Such metadata may include a unique session identifier relating to a particular session established between a client device and the cloud-based data manipulation system; a user identifier that identifies the user responsible for the data manipulation event; a timestamp; the chronological position of the operation element within the revision history; the position of the data manipulation event within the data file content; the length of the data string being manipulated (the length of the data string being inserted into the data file content in the case of a data insertion operation, or the length the data string being deleted from the data file content in the case of a data deletion operation). Because each operation element may be stored in a chronological history in this way, it may be considered to have timeline-specific properties.

It will be appreciated that when a data manipulation event has occurred, and it is intended to commit it to the data file on the cloud-based data manipulation system as a corresponding newly created revision element, the revision element may first be encrypted before it is transmitted over the network. As a new revision element may comprise a succession of newly created discrete operation elements, each operation element may be encrypted in turn, as appropriate. As mentioned above, a unique seed string may be used in the encryption of each operation element.

In one implementation of the Revision Model embodiment of the invention (hereafter referred to as the “metadata implementation”), each seed string may comprise a unique combination of metadata associated with each operation element, and may be used as the input of a hashing function to produce a message digest that may then be used in the encryption process. For example, the unique seed string may comprise a concatenation of a session ID, a user ID, and the chronological position of the operation element in the chronology of all operation elements that have been recorded in the revision history to date. The advantage of creating the seed string in this way is that all components of the seed string are inherent in and thus native to the data file as it is stored on the cloud-based storage device. As such, it is not necessary to resort to “out-of-band” seed string storage solutions such that multiple collaborators may access the seed strings and therefore concurrently access the encrypted data file. By “out-of-band”, it is meant that the seed string would be externalized and stored disparately from the data file in—for example—a separate metadata file. The disadvantage of out-of-band solutions is that inclusion of an additional resource (such as a separate metadata file) greatly complicates the coordination and synchronization process when multiple collaborators are manipulating the data file. This is particularly the case in scenarios where the encryption application (such as bespoke plug-in 379 of FIG. 3 or bespoke extension 459 of FIG. 4) and the cloud based data manipulation system are provided by independent parties. In this scenario, the party responsible for providing the encryption application may not be able to alter the functionality of the cloud based data manipulation system in order to accommodate the encryption function because the cloud based data manipulation system is out of their control. In such scenarios, it is particularly preferable to devise an encryption application that “plugs in” to the cloud based data manipulation system in as unobtrusive a manner as possible. Tightly binding the seed string data to the data file such that no externalized data (i.e. out-of-band resources) have to be consulted and manipulated in the course of encryption/decryption is a key step in achieving such unobtrusiveness.

In a second implementation of the Revision Model embodiment of the invention (hereafter referred to as the “initialization vector implementation”, each seed string comprises a randomly or pseudorandomly generated initialization vector that is probabilistically unique. However, a challenge associated with using non-native data (such as an initialization vector) in the encryption of each operation element is how to ensure these non-native data are stored without resorting to out-of-band solutions, which is undesirable for the reasons described in the above paragraph. For the initialization vector implementation of the Revision Model, this is preferably achieved in parallel with the encryption process. Rather than merely converting a “plaintext” insertion operation (an insertion operation comprising the non-encrypted data) into its corresponding “ciphertext” insertion operation (an insertion operation comprising the encrypted data), the plaintext insertion operation is replaced by an insertion of both the encrypted data and the non-native data (such as the initialization vector). This may be done by way of one or more insertion operations. Critically, this must be done in such a way that when the data file is decrypted by a decryption engine, the decryption engine can accurately identify the manner in which the encrypted data and non-native data have been inserted, such that the non-native data may be used to decrypt the encrypted data and such that the decrypted data alone is then returned. Additionally, in a multiple collaboration environment, this must be done in such a way that data pertaining to the local version of the data file is conserved and synchronised. For example, where the data file is a document being concurrently edited by multiple collaborators, the position of each collaborator's cursor must be conserved while different collaborators' edits are applied to the document. Ensuring such conservation is known as document synchronization. When plaintext insertion operations of a given length are replaced by net ciphertext insertion operations of a different length, serious synchronization issues can arise whereby the state of local versions of the data file are not in agreement with one another and with the version of the data file stored on the cloud based server. Such synchronization issues can give rise to error messages in the client applications 212, 222 and/or productivity/office software 213, 223, or even cause these programs to crash. One way to ensure such synchronization is maintained while incorporating the non-native data into the data file is to ensure that the encrypted version of the data file is of the same length as the non-encrypted version. This can be done by applying one or more deletion operations to accompany the one or more insertion operations such that the net effect of the deletion operations and the insertion operations is to insert substitute data equal in length to the non-encrypted data. Optionally, the substitute data may comprise the encrypted data, with the deleted portion comprising the non-native data. Alternatively, the substitute data may comprise dummy data, and the deleted portion may comprise both the encrypted data and the non-native data. A specific example of this implementation will be described in further detail below, under the heading “Encryption/Decryption”.

Encrypting only the revision element (and specifically, the operation elements contained therein) is efficient, because only the necessary data (i.e. the manipulated data) are encrypted and sent, rather than the entire data file. Consequently, resources are not wasted encrypting and sending parts of the data file that have not undergone any modification during the data manipulation event in question. The revision history may thus comprise a history of successive encrypted operation elements, thereby ensuring that the data file is stored on the cloud-based data manipulation system in a secure fashion. The manner in which the revision elements may be encrypted are described in greater detail below.

### Revision Model—Data File Reconstruction

When a user wishes to recall an encrypted data file from storage on the cloud based data manipulation system in the Revision Model embodiment of the invention, the data file may be reconstituted from the history of encrypted revision elements. One manner of doing so is by constructing a locally stored data architecture that is representative of the data file. The data architecture may be constructed in stepwise fashion, processing each revision element in turn by individually retrieving them (beginning with the first revision element) and applying their corresponding data manipulation event to the data architecture. If a data manipulation event represents more than one discrete operation element, then these operation elements are applied chronologically. This construction may continue until all revision elements have been applied and the data architecture is fully constructed and thus fully representative of the data file as recorded in the retrieved revision history. Use of a data architecture to reconstruct a representation of the data file may assist in efficient processing of the revision history. In one embodiment of the invention, the revision history may be retrieved on the secondary channel.

In one embodiment, the data architecture may comprise a directory data structure and an associated set of “data file piece” data structures. In this embodiment, each data file piece may store a number of values that allow it to reference a specific string of data content. The piece may store the source of the referenced data content string, and further mitigating values to isolate the referenced data content string from the source if the source comprises a larger string of data. Such mitigating values may include an offset value and a string length. The data content strings referenced by a complete set of data file pieces, when taken together, may collectively make up the complete data file content as embodied in the revision history. To aid in the assembly of the data content strings, the pieces may be listed in the directory in accordance with where their referenced data content strings are to be positioned within the data file content. For the purposes of explaining this process further, data content strings will be referred to as data file strings once they have been inserted into the data file.

As the constituent operation elements of revision elements are applied to these data structures, new pieces may be added, existing pieces may have their content references modified, existing pieces may have the position of their referenced content within the data file content modified, and/or existing pieces may be deleted. In each case, the directory is updated accordingly. In this way, each operation element within a revision element may be applied in turn (and each revision element may then be applied in turn) to the directory and associated set of data file pieces until all operation elements have been applied in chronological order, and the directory and associated set of pieces are fully representative of the data file as recorded in the retrieved revision history.

A directory data structure—if used—may be of any suitable type, for example, a self-balancing binary search tree. A self-balancing binary search tree, as will be readily understood by the skilled person, is a node-based data structure where each node has a value and is connected to no more than two child nodes. Each node may also be connected to a single parent node. Conventionally, child nodes on the left subtree of a given node all have values less than that of the given node, whereas child nodes on the right subtree of the given node all have values more than that of the given node. As additional nodes are added to the tree, the nodes in the tree may be rearranged to keep the tree height (the number of “generations” of nodes) to a minimum, hence it is self-balancing. In the context of this embodiment of the invention, each node in the self-balancing binary search tree relates to one of the data file piece data structures, and the value of each node is the position of the data content string (referenced by the piece) within the data file content.

The data file may be assembled for viewing from the fully constructed data architecture. In the embodiment where the data architecture comprises a directory and associated set of pieces, the data content strings referenced by the pieces may be amalgamated in accordance with their location within the data file, as dictated by the directory. The data content strings may be decrypted individually prior to assembly, or the assembled data file content (comprising a contiguous set of data file strings) may be decrypted en blocPreferably, each data content string is decrypted individually, as will be described in further detail below.

FIG. 8 illustrates a method by which the data architecture may be constructed. A client device (as illustrated by 110, 120, 210 and 220 of FIGS. 1 and 2) prompted to recall an encrypted data file from the cloud based data manipulation system (130, 230 of FIGS. 1 and 2) in accordance with the Revision Model embodiment of the invention may first request and load 801 a revision history from the system 130, 230. The device may subsequently initialize a data architecture representative of the data file, to which the modifications may be made as revision elements from the loaded revision history are applied. In the described embodiment, after step 801, a directory data structure in the form of a self-balancing binary search tree data structure is initialized 803, and provision is made for a set of “data file piece” data structures. It will be appreciated that at this stage, before any revision element is applied, no data file pieces will yet exist in the set of data file pieces (because no data file content has yet been obtained from the loaded revision history), and accordingly, the tree will be blank.

Subsequent to the initialization of the binary search tree at 803, the device at step 804 may check whether there are any remaining revision elements yet to be processed. It will be appreciated that in the event that no revision elements have yet been processed, this step will result in the processing of the first revision element in the loaded revision history. In the event all revision elements have been processed, the search tree and associated set of pieces may be stored 809 for use in subsequent assembly for viewing and/or modification of the data file. In the event revision elements exist that have yet to be processed, the device will then set about applying the data manipulation event embodied in the next revision element to the search tree and associated set of data file pieces by proceeding to step 805.

As discussed above, a data manipulation event embodied in a revision element may comprise a plurality of operation elements, and so processing of the revision element may entail the sequential application of these operation elements to the search tree and associated set of data file pieces. Accordingly, after step 804, the device may then check in step 805 whether the revision element currently being processed comprises any outstanding discrete operation elements that have not yet been applied to the search tree and associated set of data file pieces. If all operation elements have been applied, it can be concluded that the revision element in question has been fully processed, and the device returns to step 804. However, if there is at least one outstanding operation element that must be applied, the device then checks, at step 806, whether the next operation element represents a discrete data string insertion or a discrete data string deletion. In the event an insertion is detected, the insertion is applied in step 807 to the search tree and associated set of data file pieces in the manner described below with reference to FIG. 9. Likewise, in the event a deletion is detected, the deletion is applied in step 808 to the search tree and associated set of data file pieces in the manner described below with reference to FIG. 10. Once the insertion or deletion has been applied, the device then returns to step 805.

The application of discrete insertion or deletion operation elements will now be described in the context of the Revision Model embodiment of the invention.

### Revision Model—Data File Reconstruction—Insertion Operation Elements

When the construction of a search tree and associated set of pieces is first initiated, the tree is empty, and no pieces yet exist. The first time an operation element comprising a data insertion operation is applied to the empty tree, a first piece is generated and the data content string it references is the content of this first insertion operation element. It also sets the mitigating values to illustrate that the full content of the insertion operation element is being referenced, for example by setting the offset=0 and the length=n where n is the length of the inserted string. A corresponding node will be generated in the tree, with an established relationship to this piece. The content position of this referenced data content string within the data file content will be recorded in the search tree as the node's value. Because this is the first insertion operation in the history of the data file's construction, it will be the first bit of content in the data file. Accordingly, this data content string—when inserted—is to be positioned at the start of the data file content; the “first” position within the data file content. Therefore, the newly created node will be assigned a value corresponding to this first position.

FIG. 9a is a visualization of a search tree 901 and associated set of data file pieces 903 that have only undergone a single insertion operation, such as that described in the previous paragraph. As such, the search tree 901 only comprises a single node 902, and the set of data file pieces 903 only comprises a single piece 904. As is represented by the dashed line, the single node 902 is related to the single piece 904. In accordance with the preceding paragraph, the single piece 904 references the content of the first insertion operation element as the source of the data content string, and sets its mitigating values to length=n, and offset=0. The data content string referenced by the piece 904 is at this point the only content in the data file represented by tree 901 and associated set of data file pieces 903. Accordingly, this string will be positioned at the start of the data file content, and so node 902 which relates to piece 904 will be assigned the value “1” (i.e. node value=content position=1).

FIG. 9b illustrates a visualization of the data file 911 as represented by the search tree and associated set of data file pieces of FIG. 9a in the event the data file was to be assembled. As can be seen, the assembled data file is comprised of a data file string 914 corresponding to the data content string referenced by the single piece 904 of FIG. 9a. The data file string 914 therefore also has a length=n, and is located at content position=1 within the data file. In the event that the revision history only comprises a single revision element comprising a single operation element comprising this single insertion operation, then FIG. 9b would represent the data file assembled from the fully constructed tree and associated set of pieces. In the event the revision history comprised further operation elements, then these operation elements would also have to be applied before reaching the data file as assembled from the fully constructed tree and associated set of pieces.

Subsequent insertion operations during the construction of a search tree and associated set of data file pieces will now be discussed.

FIG. 9c illustrates the visualized data file of FIG. 9b where a subsequent insertion operation element is to be applied. While in practice, this operation element will be applied to the tree and corresponding set of data file pieces, the insertion is shown here with reference to the assembled data file for illustrating the procedure on a conceptual level. In FIG. 9c, the subsequent insertion operation element is to result in the insertion of a new data content string 945. The insertion of this new data content string 945 will result in a new data file string 925 having a length (x), positioned at content position=k within the data file content. This new data content string 945 is to be inserted into the middle of the existing data file string 914. Accordingly, the existing data file string 914 is split into two separate data file strings, 928 and 929, and the inserted new data content string 945 becomes new data file string 925 positioned between data file strings 928 and 929. Thus, data file string 928 now starts at content position=1 in the data file and has a length=(k−l); data file string 925 starts at content position=k in the data file and has a length=x; and data file string 929 starts at content position=(k+x+l) in the data file and has a length=(n−k+l).

In practice, such an operation element may be applied to the data structures representative of the data file. FIG. 9d illustrates how the conceptual example of FIG. 9c may be applied in practice to the search tree 901 and associated set of data file pieces 903 depicted in FIG. 9a. A new data file piece 905 will be created and added to the set of pieces 903. The new piece 905 will be configured to reference the data content string corresponding to new data file string 925 in a manner analogous to the way piece 904 is configured to reference the data content string corresponding to data file string 914 as described above (i.e. it will indicate the content of this subsequent operation element of the revision history as the source of the data content string, and will set offset=0 and length=x). A new node 906 is created in the tree 901 that is related to new piece 905, and because the data content string referenced by piece 905 is to be inserted at content position=k in the data file content, the node value of node 906 is in turn set to k.

As this new insertion necessitates the splitting of the existing data file string 914 into two strings 928 and 929, as discussed in the preceding paragraph, existing piece 904 that references the data content string corresponding to data file string 914 is substituted for replacement pieces 908 and 909. Existing piece 904 may be deleted and pieces 908 and 909 may be newly generated and added to the set of pieces 903. Alternatively piece 904 may be modified to become either one of 908 or 909, in which case only a single additional piece is generated and added to the set of pieces 903 (this one additional piece becoming the other of the two replacement pieces). Replacement pieces 908 and 909 will be configured to reference data content strings corresponding to data file strings 928 and 929 respectively. Both pieces 908 and 909 will store a reference to the content of the first operation element of the file revision history that comprises an insertion operation as the source of their referenced data content strings. However, the mitigating values of each of these pieces will be configured to only refer to the relevant portions of this source string. As such, piece 908 will have the mitigating values offset=0 and length=(k−l), and piece 909 will have the mitigating values offset=(k−l) and length=(n−k+l). In this way, while both pieces refer to a data content string from the same source, the two strings are in fact different.

A relationship will also be established between each of these replacement pieces 908, 909 and a node in the tree 901, such that there is a one-to-one relationship between nodes in the tree and pieces in the set of pieces. In this example, piece 908 is related to node 902 and piece 909 is related to node 907. Because the data content string 928 referenced by piece 908 is to be inserted at content position=1 within the data file, the value of related node 902 is set=1. In a similar fashion, the values of nodes 906 and 907 are set=k and =(k+x), respectively.

As a result of the above process, the tree 901 now has three nodes 902, 906 and 907, and their interrelationship may potentially be represented in a number of ways. However, in accordance with the previously described self-balancing properties of the self-balancing binary search tree implemented in the described embodiment, the tree 901 will rearrange the nodes so that the parent node is node 906 because it is related to the piece 905 that references the data string positioned in the middle of the data file content. As such, node 906 may have one left child node 902 (having a value less than the parent node), and one right child node 907 (having a value greater than the parent node). This results in a tree of minimum height (i.e. a single “generation” of nodes, where other arrangements might have resulted in two “generations”).

In contrast to the insertion operation described with respect to FIGS. 9c and 9d, if an insertion operation is to be performed on the data structures represented by FIG. 9a and visualised in FIG. 9b where the data content string is instead to be inserted into the very beginning or the very end of the data file, the process would be less complex. In either event (insertion at beginning or end), it would not be necessary to replace the existing piece 904 with two pieces 908 and 909, each respectively referencing new data file strings 928 and 929 in place of the existing data file string 914. It would be readily understood by the skilled person that in the event the new data content string is to be inserted at the end of the data file, the existing piece 904 and related node 902 may remain unmodified as the new piece and related new node are added. In the event the new data content string is to be inserted at the beginning of the data file it would be sufficient to modify the value of existing node 902 to account for the shift in position of data file string 914 within the newly-modified data file content.

It will be readily appreciated that the insertion processes described in the preceding paragraphs with respect to FIGS. 9c and 9d may equally apply where the tree comprises a plurality of nodes and the set of data file pieces comprises a corresponding plurality of pieces. In the event a plurality of data file strings already exists, the only other consideration is that the position of some of these existing data file strings may have to be moved. In such circumstances, the process will proceed as described above, but will also update the node values relating to the pieces having data content strings that correspond to such data file strings.

### Revision Model—Data File Reconstruction—Deletion Operation Elements

FIGS. 10-12 illustrate how a deletion operation may be applied to a data architecture that is representative of the data file in accordance with the embodiment of the invention where the data architecture comprises a self-balancing binary search tree and an associated set of data file pieces.

FIG. 10a is similar to FIG. 9a in that it depicts a search tree 1001 and associated set of data file pieces 1003 wherein the tree 1001 comprises a single node 1002 and the set of data file pieces 1003 comprises a single piece 1004 related to said node 1002. Only one insertion operation element from the revision history (inserting content of length=n) has been so far applied to these data structures. The piece 1004 references a data content string the source of which is the applied insertion operation element. In this example, no subsequent data deletion operation elements have been applied to either end of the data file, and so the data content string referenced by the piece will be the full content of the insertion operation element. Thus, the mitigating values stored in the piece 1004 may be offset=0 and length=n.

FIG. 10b illustrates a visualization of the data file 1011 as represented by the search tree 1001 and associated set of data file pieces 1003 of FIG. 10a in the event the data file was to be assembled from these data structures. As can be seen, the assembled data file is comprised of a data file string 1014 corresponding to the data content string referenced by the single piece 1004 of FIG. 10a. The data file string 1014 therefore also has a length=n, and is located at content position=1 within the data file content.

FIG. 10c illustrates the visualized data file 1011 of FIG. 10b where a deletion operation element is then to be applied. While in practice this deletion will be applied to the tree 1001 and corresponding set of data file pieces 1003 as depicted in FIG. 10a, the deletion is shown here with reference to the assembled data file 1011 for illustrating the procedure on a conceptual level. In FIG. 10c, the deletion operation element comprises deletion of a portion 1025 of the existing data file string 1014. The portion to be deleted 1025 begins at content position=h of the data file content and has a length of (x), thereby extending from content position=h for x positions up to and including content position=(h+x). The next undeleted content position=(h+x+l), will be referred to as (k) for brevity. Therefore, the last deleted content position=(h+x) may also be written as (k−l). Because the portion to be deleted 1025 is to be deleted from the middle of the existing data file string 1014, the existing data file string 1014 is split into two separate data file strings, 1028 and 1029. Thus, data file string 1028 now starts at content position=1 in the data file content and has a length=(h−l), and data file string 1029 starts at content position=h in the data file content and has a length=(n−k).

In practice, such a deletion operation element may be applied to the data structures representative of the data file. FIG. 10d illustrates the result of applying the deletion operation element depicted in the conceptual example of FIG. 10c to the search tree 1001 and associated set of data file pieces 1003 depicted in FIG. 10a. As this new deletion necessitates the splitting of the existing data file string 1014 into two strings 1028 and 1029, as discussed in the preceding paragraph, existing piece 1004 that references the data content string corresponding to data file string 1014 is substituted for replacement pieces 1008 and 1009. Existing piece 1004 may be deleted and pieces 1008 and 1009 may be newly generated and added to the set of pieces 1003. Alternatively piece 1004 may be modified to become either one of 1008 or 1009, in which case only a single additional piece is generated and added to the set of pieces 1003 (this one additional piece becoming the other of the two replacement pieces). Replacement pieces 1008 and 1009 will be configured to reference data content strings corresponding to data file strings 1028 and 1029 respectively. Both pieces 1008 and 1009 will store a reference to the content of the first insertion operation element of the file revision history as the source of their referenced data content strings. However, the mitigating values of each of these pieces will be configured to only refer to the relevant portions of this source string. As such, piece 1008 will have the mitigating values offset=0 and length=(h−l), and piece 1009 will have the mitigating values offset=(k−l) and length=(n+l−k). In this way, while both pieces refer to a data content string from the same source, the two strings are in fact different.

In contrast to the deletion operation described with respect to FIGS. 10c and 10d, if a deletion operation element is to be applied to the data structures represented by FIG. 10a and visualised in FIG. 10b where the portion of the data content to be deleted is at the very beginning or the very end of the data file, the process would be less complex. In either event (deletion at beginning or end), it would not be necessary to replace the existing piece 1004 with two pieces 1008 and 1009, each respectively referencing new data file strings 1028 and 1029 in place of the existing data file string 1014. In either event, it would be sufficient to merely modify the mitigation values of existing piece 1004, modifying the length value in the event of a deletion at the end of the data file and modifying both the length and the offset in the event of a deletion at the start of the data file.

It will be appreciated that a deletion operation such as that in the preceding paragraphs with reference to FIGS. 10c and 10d, the process will fundamentally be the same regardless of how many data file strings are in the data file (and hence, how many pieces are in the data file piece set). In the event a plurality of data file strings already exists, the only other consideration is that the position of some of these data file strings may have to be moved. It is therefore sufficient—in addition to carrying out the procedure described in the preceding paragraphs—to update the node values relating to the pieces having data content strings that correspond to such data file strings.

FIG. 11a depicts a search tree 1101 and associated set of data file pieces 1103 wherein the tree 1101 comprises two nodes 1002, 1005, and the set of data file pieces 1003 comprises two pieces 1007, 1109 related respectively to said nodes 1102, 1105. In the present example this configuration of data structures is the result of two successive insertion operations, and as such the pieces 1107, 1109 reference data content strings from different insertion operation elements, the mitigating data being set accordingly. It will be appreciated that a configuration of data structures very similar to this could also be the result of an insertion operation, followed by a deletion operation at content position=j in the data file content. However, in that case, both pieces 1107, 1109 would reference data content strings from the same insertion operation element, and the mitigating values of the pieces would be different to those depicted in FIG. 11 c in order for each piece to identify the relevant part of the content of the insertion operation element. In this example, no subsequent data deletion operation elements have been applied to the data structures, and so the data content strings referenced by the pieces will correspond to the full content of the respectively referenced insertion operation elements. As such, the mitigating values stored in piece 1107 may be offset=0 and length=(j−l), and the mitigating values stored in piece 1109 may be offset=0 and length=(n−j).

FIG. 11b illustrates a visualization of the data file 1111 as represented by the search tree 1101 and associated set of data file pieces 1103 of FIG. 11a in the event the data file was to be assembled from these data structures. As can be seen, the assembled data file is comprised of two data file strings 1117 and 1119 corresponding respectively to the data content strings referenced by the pieces 1107 and 1109 of FIG. 11a. The data file strings 1107 and 1109 therefore also have length=(j−l) and length=(n−j) respectively, and are respectively located at content position=1 and content position=j within the data file content.

FIG. 11c illustrates the visualized data file 1111 of FIG. 11b where a deletion operation element is then to be applied. While in practice, this deletion will be applied to the tree 1101 and corresponding set of data file pieces 1103 as depicted in FIG. 11a, the deletion is shown here with reference to the assembled data file 1111 for illustrating the procedure on a conceptual level. In FIG. 11c, the deletion operation element comprises deletion of a portion 1125 of the existing data file content. The portion to be deleted 1125 begins at content position=h of the data file content and has a length of (x), thereby extending from content position=h for x positions up to and including content position=(h+x). The next undeleted content position, (h+x+l), will be referred to as (k) for brevity. Therefore, the last deleted content position, (h+x) will may also be written as (k−l). As can be seen, therefore, this portion to be deleted 1125 is directed to the trailing end of end of data file string 1117 and to the leading end of data file string 1119.

Because the portion to be deleted 1125 is to be deleted from the ends of two existing data file strings 1117, 1119, it is not necessary to split these strings. It is sufficient merely to truncate both data file strings in accordance with the deletion operation, and to modify the content position in the data file content of data file string 1119. Thus, while data file string 1117 still starts at content position=1, it now has a length=(h−l). Data file string 1119 now starts at content position=h in the data file and has a length=(n−k).

In practice, such a deletion operation may be applied to the data structures representative of the data file. FIG. 11d illustrates the result of applying the deletion operation element depicted in the conceptual example of FIG. 11c to the search tree 1101 and associated set of data file pieces 1103 depicted in FIG. 11a. This new deletion does not necessitate the further splitting of the existing data file strings 1117 and 1119, so it is not necessary to create new nodes or pieces. Rather, it is merely sufficient to modify the mitigating values in the pieces 1107, 1109 corresponding to data file strings 1117 and 1119 to account for their truncation, and to modify the node value of node 1105 that is related to piece 1109 to account for its change in content position within the data file. As such, piece 1107 will have the mitigating values offset=0 and length=(h−l), and piece 1109 will have the mitigating values offset=(k−j) and length=(n+l−k). In this way, while both pieces still refer to data content strings from the respective sources they had previously referred to, the exact content within these sources has now changed.

It will be appreciated that a deletion operation such as that depicted in FIGS. 11 c and 11d where the portion of data file content to be deleted extends over the trailing ends of two contiguous data file strings, the process will be the same regardless of how many data file strings are in the data file (and hence, how many pieces are in the data file piece set). In the event more than two data file strings already exist, the only other consideration is that the content position of some of the data file strings other than those being modified may have to be moved. It is therefore sufficient—in addition to carrying out the procedure described in the preceding paragraphs—to update the node values relating to the pieces having data content strings that correspond to such data file strings. It will be appreciated that in the event that values of nodes are altered in this way, the search tree may rearrange itself in accordance with the self-balancing principles already described.

FIG. 12a depicts a search tree 1201 and associated set of data file pieces 1203 wherein the tree 1201 comprises three nodes 1204, 1205, 1206, and the set of data file pieces 1203 comprises three pieces 1207, 1208, 1209 related respectively to said nodes 1204, 1205, 1206. In the present example this configuration of data structures is the result of three successive insertion operations, where the second and third insertion operations were each at the end of the data file. As such, the pieces 1207, 1208, 1209 reference data content strings from different insertion operation elements, the mitigating data being set accordingly. It will be appreciated that a configuration of data structures very similar to this could also be the result a number of other combinations of insertion and deletion operations. For example, a first insertion operation, followed by a second insertion operation at content position=i in the data file would result in this configuration, as would a first insertion operation, followed by a second insertion operation at the end of the data file, followed subsequently by a deletion operation at either content position=i or content position=j of the data file. However, in that case, pieces 1207, 1208, 1209 may reference data content strings from the same insertion operation elements, and the mitigating values of the pieces would be different to those depicted in FIG. 12c in order for each piece to identify the relevant part of the content of the relevant insertion operation element. In this example, no subsequent data deletion operation elements have been applied to the data structures, and so the data content strings referenced by the pieces will correspond to the full content of the respectively referenced insertion operation elements. As such, the mitigating values stored in piece 1207 may be offset=0 and length=(i−l); the mitigating values stored in piece 1208 may be offset=0 and length=(j−i); and the mitigating values stored in piece 1209 may be offset=0 and length=(n−j).

FIG. 12b illustrates a visualization of the data file 1211 as represented by the search tree 1201 and associated set of data file pieces 1203 of FIG. 12a in the event the data file was to be assembled from these data structures. As can be seen, the assembled data file is comprised of three data file strings 1217, 1218 and 1219, corresponding respectively to the data content strings referenced by the pieces 1207, 1208 and 1209 of FIG. 12a. The data file strings 1207, 1208 and 1209 therefore also have length=(i−l), length=(j−i) and length=(n−j) respectively, and are respectively located at content position=l, content position=i, and content position=j within the data file content.

FIG. 12c illustrates the visualized data file 1211 of FIG. 12b where a deletion operation element is then to be applied. While in practice, this deletion will be applied to the tree 1201 and corresponding set of data file pieces 1203 as depicted in FIG. 12a, the deletion is shown here with reference to the assembled data file 1211 for illustrating the procedure on a conceptual level. In FIG. 12c, the deletion operation element comprises deletion of a portion 1225 of the existing data file content. The portion to be deleted 1225 begins at content position=h of the data file content and has a length of (x), thereby extending from content position=h for x positions up to and including content position=(h+x). The next undeleted content position, (h+x+l) will be referred to as (k) for brevity. Therefore, the last deleted content position=(h+x) will also be written as (k−l). As can be seen, therefore, this deletion portion 1225 is directed to the trailing end of data file string 1217, to the entirety of data file string 1218, and to the leading end of data file string 1219.

Because the ends of two existing data file strings 1217, 1219 are to be deleted it is not necessary to split these data file strings. Furthermore, because data file string 1218 is to be deleted in its entirety, this data file string 1218 may simply be removed en bloc. Therefore, it is sufficient merely to remove data file string 1218, and to truncate both data file strings 1217 and 1219 in accordance with the deletion operation, then to modify the content position in the data file of data file string 1219. Thus, while data file string 1217 still starts at content position=1, it now has a length=(h−l). Data file string 1219 now starts at content position=h in the data file content and has a length=(n−k). As can be seen, data file string 1218 has been removed.

In practice, such a deletion operation element may be applied to the data structures representative of the data file. FIG. 12d illustrates the result of applying the deletion operation element depicted in the conceptual example of FIG. 12c to the search tree 1201 and associated set of data file pieces 1203 depicted in FIG. 12a. This new deletion does not necessitate the further splitting of the existing data file strings 1217 and 1219, and necessitates the removal of existing data file string 1218. Therefore it is not necessary to create new nodes or pieces. Rather, it is merely sufficient to modify the mitigating values in the pieces 1207 and 1209 corresponding to data file strings 1217 and 1219 to account for their truncation, to modify the node value of node 1206 that is related to piece 1209 to account for its change in content position within the data file, and to delete piece 1208 from the set of data file pieces 1203 along with deleting its related node 1205 from the search tree 1201. As such, piece 1207 will have the mitigating values offset=0 and length=(h−l), and piece 1209 will have the mitigating values offset=(k−j) and length=(n+l−k). In this way, while both pieces still refer to data content strings from the respective sources they had previously referred to, the exact content within these sources has now changed.

It will be appreciated that a deletion operation such as that depicted in FIGS. 12c and 12d where the portion of data file content to be deleted extends over the entire length of at least one data file string, the process will be the same regardless of how many entire data file strings are to be deleted—it will simply be a matter of deleting the data piece and related node corresponding to every data file string deleted in this way. Furthermore, the process will proceed analogously, regardless of whether the portion of deleted file content extends over the trailing end of a data file string, or whether it merely ends at a data file string boundary. If the deleted portion ends at a data file string boundary it merely means that it will not be necessary to amend the mitigating values of the piece corresponding to the data file string bounding the deleted portion. In addition, this process will proceed in a similar fashion, regardless of how many data file strings are in the data file (and hence, how many pieces are in the data file piece set). In the event more than three data file strings already exist, the only other consideration is that the content position of some of the data file strings other than those being modified may have to be moved. It is therefore sufficient—in addition to carrying out the procedure described in the preceding paragraphs—to update the node values relating to the pieces having data content strings that correspond to such data file strings.

It will be appreciated that in the event that values of nodes are altered as a result of any of the versions of the operations described with reference to FIGS. 9-12 or any combination of operations deriving therefrom, the search tree may rearrange itself in accordance with the self-balancing principles already described.

### Revision Model—Data File Reconstruction—Practicalities

When the data structures as referred to in FIGS. 8-12 have been fully constructed from the revision history on the client device, the data file may then be decrypted as will be described in further detail below, and then assembled into the data file for viewing and or further modification. Referring back to FIG. 2, the data file may be assembled from the fully constructed data structures by client applications 212, 222 and passed to respective web browsers 215, 225 for presentation to the users of respective client devices 210, 220 for viewing purposes. Alternatively, the data file may be assembled from the fully constructed data structures by productivity/office software 213, 223, which also presents the data file to the users of respective client devices 210, 220 for viewing purposes. The presented data file may then be modified by the user via the data manipulation functionality provided by client applications 212, 222 or by productivity/office software 213, 223 as described above with reference to FIGS. 5 and 6.

As previously mentioned, one of the advantages of a cloud-based data manipulation system is that it allows multiple users to work on a file concurrently. It will be appreciated however, that in the event there are multiple users collaborating via a plurality of client devices and are working on the data file at the same time, it is desirable to dynamically update the data file viewed by each user whenever a new data file element is committed to the data file. In the Revision Model embodiment of the invention, this may be achieved by configuring the cloud based data manipulation system to relay a new revision element to all collaborating client devices once the revision element has been stored in the data revision history. In this way, the collaborating client devices may update their search tree and data file piece structures to account for the new data manipulation event embodied in the new revision element. The collaborating client devices may then also update the data file accordingly as it is being viewed by each user. In an alternative embodiment, it may be preferable for the client devices configured to periodically request any newly committed revision elements from the cloud-based data manipulation system, rather than for the cloud-based data manipulation system to transmit the revision elements of its own volition.

### Revision Model Embodiment—Enhancements

In one aspect of the Revision Model embodiment, the regular revision elements in a data file's revision history may optionally be interspersed with “snapshot” revision elements. Snapshot revision elements may contain the entire content of the data file as it was when the snapshot was created. As such, a snapshot revision element may comprise the aggregate of all preceding revision elements. Such snapshot revision elements may be used as a shortcut when reconstituting a file from the revision history. In this embodiment of the invention, a device that is reconstituting a data file from a revision history may begin at the most recent snapshot revision element rather than beginning at the very first operation element in the very first revision element in the revision history. Accordingly, the processing and decryption of all revision elements chronologically preceding the selected snapshot revision element may be deemed unnecessary, and processing resources are conserved as a result. Snapshot revision elements may comprise an identifier to allow the device reconstituting the data file to recognize them when the data file history has been retrieved, in order for them to be used in this way.

Snapshot revision elements may be generated by client application 312, depending on the embodiment of the invention. The generation of a snapshot revision element may be triggered, and performed by the application 312 without the need for user input. In one embodiment, the trigger may be in the form of a response from the cloud-based data manipulation system 330 confirming that a previous revision element transmitted by the application 312 was successfully stored in the data file revision history stored thereon. The application 312 may be configured such that the response only triggers the generation of a snapshot revision element in the event the response meets certain criteria. For example, the cloud based data manipulation system 330 may transmit a response to the application 312 that comprises a value corresponding to the chronological position within the revision history of the newly stored operation element comprised in the revision element. In such a case, the triggering criteria may be set such that a trigger only occurs if the value is a multiple of a predetermined fixed-value integer. It will be appreciated that while the above example is discussed in the context of the embodiment of the invention set out in FIG. 3, the snapshot revision element feature may equally be implemented in the context of the embodiment of the invention depicted in FIG. 4, in which case productivity/office software 452 fulfils the role of client application 312 and the cloud based data manipulation system is referenced by numeral 430. As has previously been mentioned, revision elements may correspond to the mutations referred to in FIGS. 5 and 6. Therefore, regular revision elements may be transmitted to the cloud based data manipulation system using the primary channel. However, contrary to this, snapshot revision elements may be transmitted instead over the secondary channel.

When a data file is retrieved at the start of a communication session between a client device and the cloud based data manipulation system, it will be understood that it would be possible to commence construction of the search tree and set of pieces from the most recent snapshot revision element because it contains all the data file content up to the point that the snapshot was recorded. However, in the event there are multiple users collaborating via a plurality of client devices and are working on the data file at the same time, it is desirable to dynamically update the data file viewed by each user whenever a new revision element is stored as described above. This is equally the case when a new snapshot revision element is generated. In the event a snapshot revision element is generated by a client device and it is desirable to update the search trees and data file piece sets of all other collaborating client devices in real time with the newly-created snapshot revision element (as might have been generated by one of the client devices), it is necessary to ensure that the all existing nodes in the search trees and all corresponding existing data file pieces in the data file piece sets of all other collaborating client devices are purged. In one example, this may be achieved by encoding a snapshot revision element as a pair of operation elements: an initial deletion of the entire contents of the data file; and a subsequent insertion of the entire contents of the data file. In the embodiment described with respect to FIGS. 8-12 above, this would entail deleting all nodes from the search tree and all the related data file pieces from the piece set, followed by a inserting a single node and related data file piece which are an aggregate of all the deleted nodes and related data file pieces.

### Revision Model—Unique Seed String Management

As stated above, the metadata implementation of the Revision Model embodiment of the invention relies on a unique combination of metadata particular to each operation element comprised within a revision element to generate a seed string for use in the encryption process. Consequently, in order to successfully decrypt content encrypted in such a way, it must be possible to successfully identify the metadata used in the encryption process. One example of a seed string for use in encryption of an operation element as given above is a concatenation of a session ID, user ID and the predicted chronological position of the operation element in the chronology of all operation elements that have been recorded in the revision history to date (hereafter referred to as “historical operation number”). However, in the event multiple users are working on a data file at the same time, it is possible that at any single time, two collaborators may both incorporate the most up-to-date historical operation number into the seed string used in the encryption of the operation element they each respectively transmit to the cloud based data manipulation system, resulting in a “collision”. It follows that while one collaborator's operation element will be assigned the predicted historical operation number, the other collaborator's revision will be assigned the subsequent historical operation number. As such, a revision will have been stored in system having an operation element encrypted using historical operation number “n”, whereas attempts to decrypt this operation element will be carried out using historical operation number “n+l”. This would clearly lead to an incorrect decryption, and therefore presents a problem.

One solution to this problem would be to use a different seed string. Instead of using the historical operation number, it could be possible to use the chronological position of the operation element in the chronology of all operation elements that have been recorded with that session ID (hereafter referred to as the “session operation number”), and to instead concatenate this value with the session ID and user ID. This obviates the danger (as outlined above) of using an incorrect value in the encryption process. As the session operation number can only be updated via submissions from the client device associated with the session in question, it would not be possible to make a mistaken assumption about the next session operation number that is to be ascribed to an operation element. For decryption purposes, it will be possible to derive the session operation number by counting the number of pre-existing operation elements having a given session ID in the revision history. In terms of the cryptographic robustness of this approach, an actively attacking cloud-based data manipulation system may subvert uniqueness by issuing either non-unique session Ids or by selectively omitting certain members of the revision history as a means to taint the session operation number. However diligent client devices may monitor session Ids and the revision history to guard against such an eventuality.

While the solution in the above paragraph presents a solution to the collision problem, it effectively precludes the use of snapshots discussed above, because complete revision histories are integral to its functionality. In order to avoid collisions but to allow for the use of snapshots, the historical operation number of the most recent previous operation element recorded using that session ID could be used, and this value concatenated with the session ID and the user ID. This technique allows collisions to be avoided while also avoiding the need for the full revision history, thereby allowing snapshots to be used.

An advantage of the initialization vector implementation of the Revision Model embodiment, is that using randomly or pseudorandomly generated initialization vectors obviates the problems associated with the metadata implementation as expressed in the above paragraphs. With the initialization vector implementation, it will always be clear what seed string is associated with each data manipulation operation. Rather, as previously described, the challenge with the initialization vector embodiment is how to include the non-native initialization vector data in the data file—such that it is not necessary to revert to out-of-band solutions—without causing synchronization problems. As already stated, this may be achieved by replacing the plaintext insertion operation with one or more insertion operations collectively comprising the insertion of the encrypted data and the non-native initialization vector (in such a way that the two parts can be recognized and treated accordingly by the decryption engine) followed by one or more deletion operations such that the net effect of the insertion operations and the deletion operations is to insert substitute data (of a length identical to the length of data in the plaintext insertion operation) into the data file. A specific example of this implementation will be described in further detail below, under the heading “Encryption/Decryption”.

### Encryption & Decryption

FIG. 13 illustrates the process of generating a keystream cipher for use in encrypting the data in accordance with an embodiment of the invention. As described above, when data within a data file is manipulated, the data file element containing the manipulated data (the “target” data file element) is encrypted and relayed to the cloud-based data manipulation system for storage as part of a revision element. The data contained in the target data file element (the “target plaintext”) may be encrypted using a keystream cipher.

In the metadata implementation of the Revision Model embodiment, the keystream cipher may be generated from a seed string comprising metadata unique to the data file element that is to be encrypted, by using a hashing algorithm on the seed string to produce a message digest, and running a block cipher encryption algorithm on the digest to produce a pseudorandom keystream that may be combined with the target plaintext. This keystream cipher may be referred to as a keystream “block”. As discussed above, such metadata may include, but is not limited to: a unique session identifier relating to a particular session established between a client device and the cloud-based data manipulation system; a user identifier that identifies the user responsible for the data manipulation event; a timestamp; the chronological position of the data file element; the position of the data manipulation event within the data file content; the length of the data string being manipulated (the length of the data string being inserted into the data file content in the case of a data insertion operation, or the length the data string being deleted from the data file content in the case of a data deletion operation).

In an the initialization vector implementation of the Revision Model embodiment, the keystream cipher may be generated from a block cipher encryption algorithm that has been run based on a seed string comprising an initialization vector that is unique to the data file element to be encrypted. The initialization vector may be a randomly or pseudorandomly generated sequence that is probabilistically unique.

In a preferred embodiment, the keystream block and target plaintext are combined by way of an XOR operation to produce an encrypted form of the plaintext, termed the ciphertext. In the event that the target plaintext is longer than the keystream block that is generated in the way described above, encryption may be achieved by running successive iterations of hashing and block encryption functions to produce successive keystream blocks, and encrypting successive portions of the target plaintext of corresponding length with the successive keystream blocks until the entire target plaintext has been encrypted. In an embodiment, this succession of actions may be performed in what is known as counter (CTR) mode encryption, but it will be appreciated that other methods may be employed to ensure full encryption of the target plaintext.

In CTR mode encryption, it is first determined how many successive keystream blocks will be required to allow the full target plaintext to be encrypted by comparing the length of the target plaintext with the length of a keystream block. Then, as depicted in FIG. 13, in step 1301 metadata unique to the target data file element associated with the target plaintext is used as a seed string, and a variable representing the number of blocks is initialized at zero. It is then determined in step 1302 whether sufficient blocks have already been generated to fully encrypt the plaintext. This is determined by referring to the block number variable, which can be compared to the known number of blocks required. In the event more blocks are needed, the seed string is concatenated with the block number variable, and the result is input into a hashing function in step 1303 to produce a message digest. In a preferred embodiment the hashing function may be SHA-256, but it will be appreciated that other cryptographic hashing functions may be used. The digest may then be fed into a suitable block encryption algorithm in order to generate a keystream block (step 1304). It will be appreciated that a block encryption algorithm requires the use of a secret key, and therefore it would not be possible to reproduce the keystream blocks without knowledge of this key. In a preferred embodiment, the block encryption algorithm is AES256, but it will be appreciated that other block encryption algorithms may also be used. Once a keystream block has been produced, it is combined in step 1305 with the next available unencrypted portion of the target plaintext to produce an encrypted form of this portion of the target plaintext (referred to as “ciphertext”), the ciphertext having the same length as the unencrypted portion of plaintext. The portion of target plaintext in question is then replaced by the newly produced ciphertext and the block number variable is incremented by one (step 1306). At this point, the method loops back to step 1302, where it is once more determined whether sufficient keystream blocks have been generated. However, this time the determination is made using the newly incremented block number variable. In the event that it is still the case that insufficient keystream blocks have been produced, steps 1303-1306 are repeated to encrypt the next portion of target plaintext. In the event that enough keystream blocks have been generated, the ciphertext that is the result of complete encryption of the target plaintext, is applied in step 1307 to the target data file element, replacing the target plaintext contained therein. The target data file element may then be relayed to the cloud-based data manipulation system for storage, along with any necessary associated metadata, including (in the metadata implementation of the Revision Model) the data required to produce the unique seed string used in the encryption process. In one embodiment, the necessary associated metadata may be transmitted along with the target data file element over the primary channel to the cloud-based data manipulation system. In alternative embodiments, at least some of the necessary associated metadata must be transmitted over the secondary channel to the cloud-based data manipulation system. An advantage of the CTR encryption mode is that it produces a ciphertext the same length as the plaintext. Accordingly, data may be encrypted without altering its length, which is an important synchronization consideration, as described above in the section entitled “Revision Model—overview”.

It will be appreciated that the process of generating the keystream as described above may equally be applied when decrypting a data file. The roles of bespoke plug-in 379 and bespoke extension 459 in the decryption process are analogous to their roles in the encryption process, as are their standalone application alternatives which have also been described with respect to FIG. 3 and FIG. 4. When it is desired to decrypt a data file, it (or its representative data architecture) will be passed to the bespoke plug-in 379, extension 459, or standalone application to perform the decryption. Depending on the embodiment of the invention, the data file elements themselves, or the data architecture generated from the data file elements may be decrypted.

Alternative modes of encryption, such as authenticated encryption schemes may also be utilized. Authenticated encryption schemes are semantically secure encryption schemes combined with an unforgeable authentication tag (or message authentication code), of which is Galois Counter Mode (GCM) encryption is one example, others being EAX or CCM mode. Use of such encryption schemes in the context of the invention is possible, but requires additional considerations as will now be discussed with reference to GCM encryption. As will be appreciated by those skilled in the art, GCM encryption proceeds in a manner similar to that of CTR, but additionally includes an authentication tag feature whereby an authentication tag is appended to each ciphertext thereby ensuring the integrity and authenticity of the ciphertext can be monitored. However, the addition of the authentication tag in GCM encryption means that the encrypted data produced by this encryption mode is longer than the corresponding non-encrypted data. As previously noted, this can result in potential synchronization problems. These problems can be addressed, and additional length of the encrypted data can be accommodated, in the same way that non-native data is accommodated in the initialization vector implementation of the Revision Model as discussed above. Specifically, a plaintext insertion operation may be replaced by one or more insertion operations collectively comprising the insertion of the longer encrypted data (and the non-native data in the event an initialization vector is used as the seed string) in such a way that the one or more insertions can be recognized and treated accordingly by the decryption engine. These insertions are followed by one or more deletion operations such that the net effect of the insertion operations and the deletion operations is to insert substitute data (of identical length to the length of data in the plaintext insertion operation) into the data file. There now follows a specific worked example of this in which the initialization vector implementation of the Revision Model embodiment of the invention is applied utilizing GCM encryption.

In this example, when any of the bespoke plug-in 379; the standalone application alternative to bespoke plug-in 379; the bespoke extension 459; or the standalone application alternative to bespoke extension 459 (as discussed with respect to FIG. 3 and FIG. 4) are to encrypt n bytes of data in a given plaintext insertion operation in a given revision element (the “plaintext data”), a random or pseudorandom initialization vector (IV) comprising a 16-byte array is first generated. In accordance with the GCM encryption method, it will be appreciated that IVs of other lengths may alternatively be used. The plaintext data is encrypted by GCM encryption using the 16 byte IV to produce a ciphertext comprising n bytes of encrypted data and a 16 byte authentication tag. The ciphertext is output in a byte array n+16 bytes long wherein the authentication tag and encrypted data are interleaved. As with the length of the IV, it will be appreciated that in accordance with the GCM encryption method, authentication tags of other lengths may be used. As the ciphertext byte array essentially comprises random binary data, it is run through a base64 encoder to produce an ASCII ciphertext string that comprises printable text that looks like the data of an insertion operation. The IV is similarly base64 encoded to produce an ASCII IV string and is appended to the ciphertext string delimited by an asterisk (*) to produce a single string that comprises the following concatenated constituents (where “∥” is taken to mean a concatenation): encrypted text∥authentication tag∥*∥initialization vector. A first ciphertext insertion operation is generated, comprising the first n bytes of this concatenated string (which should correspond exactly to the encrypted data portion of the string). The first ciphertext insertion operation is configured to be applied in at the location in the data file where the plaintext insertion operation was to be applied. Subsequently, a second ciphertext insertion operation is generated comprising the remaining part of the concatenated string (which should correspond exactly to the authentication tag∥*∥initialization vector portion of the concatenated string). The second ciphertext insertion operation is also configured to be applied at the location in the data file where the plaintext insertion operation was to be applied. Both of these ciphertext insertion operations are added chronologically to the given revision element in the place of the plaintext insertion operation. Subsequently, a ciphertext deletion operation is generated that has the effect of deleting a portion of the data file which is equivalent in length to the length of the second ciphertext insertion operation, starting at the location in the data file where the plaintext insertion operation was to be applied. This ciphertext deletion operation is subsequently added to the revision element.

The result of this operation is that a single plaintext insertion operation of n bytes of data at location x in a data file is replaced in a revision element by three chronologically successive data manipulation operations comprising:
1) Insertion of the encrypted data at location x in a data file;
2) Insertion of the non-native data (authentication tag, concatenation asterisk, initialization vector) at location x in the data file;
3) Deletion of the non-native data from the data file, starting at position x of the data file.

These three individual data manipulation operations are recorded independently on the cloud based data manipulation system in place of the single plaintext insertion operation. When they are applied chronologically in the reconstruction of the data file, they have the net effect of replacing the single plaintext insertion operation of n bytes of unencrypted data with a single ciphertext insertion operation of n bytes of encrypted data.

As previously mentioned, it is critical that the ciphertext insertion and deletion operations replacing the plaintext insertion operation are recognised as such by the decryption engine so that they can be handled accordingly. As such, a recognizable signature is required. The insertion and deletion operations may collectively comprise the signature in a variety of ways. The signature may comprise any recognizable pattern, and this may for example comprise a specific pattern of data comprised in one or more insertion operations (“flag data”), a pattern in the sequence of insertion and/or deletion operations, a specific pattern in the lengths or locations of one or more insertion and/or deletion operations, a specific pattern of metadata associated with one or more insertion and/or deletion operations or any combination of these. In the above example, when the data file is being reconstructed, and it is necessary to decrypt the data, it is important to be able to distinguish the ciphertext insertion operations comprising the encrypted data from the ciphertext insertion operations comprising the associated authentication tag and initialization vector. How this is done in the context of this example is described in further detail below, under the heading “Decryption—Revision Model”.

### Decryption—Revision Model

With respect to the Revision Model embodiment of the invention, decryption may take place after the data architecture has been fully constructed from the revision elements, as the data file is being assembled from the data architecture. In this Revision Model embodiment, each data file piece may be decrypted in turn. Each data file piece refers to a data content string sourced from the content of a specific insertion operation element, and therefore each piece also refers to a specific revision element. In order to decrypt the data content string of a data file piece, the insertion operation element to which the data content string refers is identified, and the unique seed string associated with said insertion operation element is obtained. In the metadata implementation of the Revision Model, this entails obtaining the necessary metadata from which to generate the seed string. In the initialization vector implementation of the Revision Model, this entails retrieving the initialization vector, as will be described in greater detail below. The keystream used to encrypt said insertion operation element is thus obtained, using the seed string and the shared secret key. Because the data content string of the piece being decrypted may only refer to a portion of the content of the insertion operation element, it is then necessary to identify the corresponding relevant portion of the keystream. The mitigating values of the piece in question are used to do this—in one example, using offset and length values. Matching pieces of ciphertext and keystream are thus isolated and applied to one another to retrieve the plaintext version of the data content string for that piece; a string corresponding to the related data file string constituent of the data file content. As the data content string of the next data file piece will have been encrypted using a different unique seed string, the decryption process must begin afresh on this next piece.

The decryption process will now be discussed in the context of the worked example of the invention discussed in the section “Encryption/Decryption” above, where the initialization vector implementation of the Revision Model embodiment of the invention used GCM encryption to encrypt the data of an insertion operation of n bytes in length. This decryption will be discussed in the context of the data file to which the insertion operation pertains. As described above, a data architecture comprising data file pieces is first assembled from the revision history of the data file. As should be understood, the non-native data comprised in the second ciphertext insertion operation element (discussed above) will not be found in any of the data architecture's data pieces once the architecture has been fully constructed. This is because these non-native data have been deleted by the subsequent ciphertext deletion operation.

During the decryption process, a data file piece comprising the full n bytes of encrypted data is taken for decryption. As previously mentioned, each data file piece is associated with a specific insertion operation element and thus a specific revision element. The specific revision element is identified, and the data manipulation operations therein are categorized. An insertion operation element is categorized as a “non-native” insertion if it bears the appropriate signature. In this example, the signature of “non-native” insertions is an insertion operation that: 1) inserts data at the same data file location as an earlier insertion operation within the same revision element; 2) inserts data greater in length than said earlier insertion operation; 3) comprises an asterisk (“*”) and 4) is completely deleted by a subsequent deletion operation within the same revision element. Utilizing this categorization process, the constituent data manipulation operations in a given revision element may be categorized such that each ciphertext insertion operation comprising encrypted data can be associated with the related ciphertext insertion operation comprising the related initialization vector and authentication tag (the associated “non-native” insertion). In this example, the relevant initialization vector and authentication tag are retrieved once the categorization process has been completed and the associated non native insertion has been identified. The initialization vector and the authentication tag are then used in GCM mode decryption (along with the secret key), producing n bytes of keystream data which is then used to convert the n bytes of encrypted data into plaintext (n bytes of unencrypted data).

It will be appreciated that if only a portion of the n bytes of encrypted data are present in the data piece, the full n bytes of the encrypted data are still retrieved from the specific insertion operation element (in this case, the first ciphertext insertion operation) for decryption purposes. Once the full n bytes of plaintext have been subsequently obtained by way of decryption as described in the above paragraph, the relevant portion of these n bytes referenced by the data file piece may be retained.

The above is presented by way of example only. It will be particularly appreciated that there are many possible means of implementing a “non-native” insertion signature such that it may be recognized as such by the categorization process. The signature described operates on the fact that via normal data manipulation conditions (i.e. by way of user input), in many cloud based data manipulation systems it is not typically possible for a multitude of data manipulation operations to reside in a single revision element. Thus, multiple data manipulation operations in a single revision element is suggestive of the above described encryption scheme at work. Similarly, insertion operations instigated by users typically only comprise one or two characters, and so, a subsequent longer insertion at the same location followed by a deletion of this subsequent longer insertion is also to be viewed as indicative of this encryption scheme. Furthermore, the asterisk (“*”) character is not in the base64 alphabet and thus is also an indicator of this encryption scheme.

It will be appreciated that in the event 100% accuracy cannot be guaranteed for the categorization process, it is preferable for the signature recognition to result in false positives as opposed to false negatives because false positives these are more easily handled. False negatives would result in the incorporation of encrypted data into the assembled data file. By contrast, false positives would result in failed decryption attempts. The decryption engine can be configured to treat an unsuccessfully decrypted insertion element as a false positive, and therefore to incorporate the data of said insertion element directly into the assembled file on the assumption that it was not encrypted to begin with.

It will be appreciated that the worked example provided is only one way that the initialization vector implementation of the Revision Model may be achieved. Similar results may be obtained, for example, by replacing a plaintext insertion operation with a pair of ciphertext insertion operations followed by a ciphertext deletion operation wherein the first ciphertext insertion comprises “dummy” data equivalent in length to the data of the plaintext insertion operation, and the second ciphertext insertion comprises the encrypted data, the authentication tag and the initialization vector.

### Further Security Enhancements

While the use of authentication tags is an inherent feature of an authenticated encryption scheme such as GCM, authentication techniques may be incorporated into embodiments of the invention in additional ways. In order to assert integrity of the data file and to prevent against tampering by a malicious cloud-based data manipulation system, or equally empowered intruder, Message Authentication Codes keyed with the shared secret key may be periodically added to the data file using the secondary channel. In this way, users can be assured of the authenticity of modifications to the data file. In the Revision Model embodiment, a Message Authentication Code may be recorded as a revision element (hereafter referred to as a MAC revision element), and the periodic addition may comprise transmitting MAC revision elements and standard revision elements for storage in an interleaved fashion. A MAC revision element comprising a valid MAC that follows a standard revision element confirms the authenticity of the standard revision element. Further, during encryption of an insertion operation, the MAC of the previous insertion operation could be fed into the encryption of the succeeding insertion operation as an additional authentication input. This would create links that define a chain of insertion operations. During decryption, the process would be repeated such that on each successful decryption of an insertion operation, the associated MAC is used as input to the succeeding insertion operation's decryption. This would have the effect of asserting the sequence and ordering of insertion operations and their associated revisions such that any tampering by the cloud-based data manipulation system or other parties, with the goal or side effect of re-ordering the document history, may be detected. This is an increased security mode, allowing for further trust in data integrity that is made possible by the use of an authenticated encryption scheme.

Anther threat scenario may also exist with respect to the embodiment of the invention set out in FIG. 3, where the retrieved client application has been surreptitiously compromised, allowing the plaintext content from the client device to be extracted and stealthily relayed. A countermeasure would entail the bespoke plug-in being configured to provide known trusted code and ignore server-supplied code, or instead, to depend on a dedicated application that replicates the cloud based data manipulation system's client-side functionalities.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal, which may be transmitted via an electrical or an optical cable or by radio or other means.

The invention is not limited to the embodiments hereinbefore described but may be varied in both construction and detail.

1. A computer-implemented method comprising:
receiving data to be inserted at a designated location of a data file;
encrypting the received data using a shared key and a seed string to produce encrypted data, wherein the encrypted data is a first encryption component and the seed string is a second encryption component;
generating one or more new data file elements collectively comprising all the encryption components, wherein the encryption components are individually identifiable, and wherein the one or more new data file elements further collectively comprise a signature that allows the one or more new data file elements to be categorized as an encrypted data file element set; and
making the one or more new data file elements available for insertion into the chronological history.

2. The method of claim 1 wherein the data file comprises a chronological history of revision elements, each of which in turn comprise said one or more chronologically ordered data file elements, and wherein the one or more new data file elements are embedded in a new revision element, and the new revision element is made available for insertion into the chronological history.

3. The method of claim 1 wherein encrypting further comprises using an arbitrary piece of data as additional authentication information, wherein the arbitrary data piece is a third encryption component.

4. The method of claim 3 wherein the encrypting is performed utilizing an authenticated encryption scheme such that encryption of the received data further produces an authentication tag, wherein the authentication tag is the arbitrary data piece.

5. The method of claim 4 therein the authenticated encryption scheme is any one of GCM, EAX or CCM.

6. The method of claim 1 wherein the one or more new data file elements further comprise flag data, wherein the flag data is a fourth encryption component, and wherein the signature in part comprises the flag data.

7. The method of claim 6 wherein the flag data comprises at least one non-base 64 character and is included as a delimiter in the one or more new data file elements immediately before the second encryption component.

8-19. (canceled)

20. A computer-implemented method comprising:
retrieving, from a data file storage medium, a chronological history of one or more data file elements corresponding to a data file;
categorizing one or more data file elements collectively comprising the signature as an encrypted data file element set;
identifying the encryption components comprised in the encrypted data file element set; and
decrypting the encrypted data file element set using the encryption components and the secret key to produce a portion of unencrypted data.

21-23. (canceled)

24. A system comprising one or more data processing apparatus programmed to perform operations comprising:
receiving data to be inserted at a designated location of a data file;
encrypting the received data using a shared key and a seed string to produce encrypted data, wherein the encrypted data is a first encryption component and the seed string is a second encryption component;
generating one or more new data file elements collectively comprising all the encryption components, wherein the encryption components are individually identifiable, and wherein the one or more new data file elements further collectively comprise a signature that allows the one or more new data file elements to be categorized as an encrypted data file element set; and
making the one or more new data file elements available for insertion into the chronological history.

25-45. (canceled)
